(19) United States
(12) Patent Application Publication
(10) Pub. No.: US 2025/0392919 A1
(43) Pub. Date: Dec. 25, 2025

(54) MULTIPLE ACCESS NETWORKS WITH NON-INTEGRATED AGGREGATION

(71) Applicant: QUALCOMM Incorporated, San Diego, CA (US)

(72) Inventors: Waqar ZIA, Munich (DE); Haris ZISIMOPOULOS, London (GB); Dario Serafino TONESI, San Diego, CA (US); Francesco PICA, San Diego, CA (US); Lenaig Genevieve CHAPONNIERE, La Jolla, CA (US)

(21) Appl. No.: 18/880,913

(22) PCT Filed: Jul. 28, 2023
(86) PCT No.: PCT/US2023/071267

§ 371 Date: Jan. 3, 2025

(30) Foreign Application Priority Data
Aug. 16, 2022 (GR) 20220100690

(51) Int. Cl. H04W 16/08; H04L 45/24; H04W 76/12; H04W 76/16

(52) U.S. Cl. CPC H04W 16/08; H04L 45/24; H04W 76/12; H04W 76/16

(57) ABSTRACT

Aspects relate to multiple access networks with non-integrated aggregation. In one aspect, a UE may communicate with a core network over a 3rd Generation Partnership Project (3GPP) network, transmit a request to the core network for a protocol data unit (PDU) session comprising a request for data aggregation across the 3GPP network and a non-integrated internet protocol (IP) network, and receive a response from the core network granting the requested PDU session, the response including identification of a core network aggregation entity and an offload percentage. The UE may also transmit data to the core network aggregation entity via the non-integrated IP network based on the offload percentage, and transmit data to the core network aggregation entity via the 3GPP network based on the offload percentage.

### CROSS-REFERENCE TO RELATED APPLICATION

The present application for patent claims priority to pending Greece application no. 20220100690, filed Aug. 16, 2022, and assigned to the assignee hereof and hereby expressly incorporated by reference herein as if fully set forth below and for all applicable purposes.

### TECHNICAL FIELD

The technology discussed below relates generally to wireless communication and, more particularly, to multiple access networks with non-integrated aggregation.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A UE may want to access data available via the core network. Traditionally this has been done using either a 3GPP access network (e.g., 5G RAN) or a non-3GPP access network (e.g., WiFi). In 5G, a UE can use multiple access networks (e.g., networks including both 5G RAN and WiFi) for data transfers but challenges for implementing and managing these features remain.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a method for wireless communication at a user equipment is disclosed. The method may include communicating with a core network over a 3rd Generation Partnership Project (3GPP) network, transmitting a request to the core network for a protocol data unit (PDU) session including a request for data aggregation across the 3GPP network and a non-integrated internet protocol (IP) network, receiving a response from the core network granting the requested PDU session, the response including identification of a core network aggregation entity and an offload percentage, transmitting data to the core network aggregation entity via the non-integrated IP network based on the offload percentage, and transmitting data to the core network aggregation entity via the 3GPP network based on the offload percentage.

In some examples, a user equipment may include a transceiver, and a processor coupled to the transceiver and configured to communicate with a core network over 3GPP network, transmit, via the transceiver, a request to the core network for a PDU session including a request for data aggregation across the 3GPP network and a non-integrated IP network, receive, via the transceiver, a response from the core network granting the requested PDU session, the response including identification of a core network aggregation entity and an offload percentage, transmit data, via the transceiver, to the core network aggregation entity via the non-integrated IP network based on the offload percentage, and transmit data, via the transceiver, to the core network aggregation entity via the 3GPP network based on the offload percentage.

In some examples, a user equipment may include means for communicating with a core network over a 3GPP network, means for transmitting a request to the core network for a PDU session including a request for data aggregation across the 3GPP network and a non-integrated IP network, means for receiving a response from the core network granting the requested PDU session, the response including identification of a core network aggregation entity and an offload percentage, means for transmitting data to the core network aggregation entity via the non-integrated IP network based on the offload percentage, and means for transmitting data to the core network aggregation entity via the 3GPP network based on the offload percentage.

In some examples, an article of manufacture for use by a UE includes a computer-readable medium having stored therein instructions executable by one or more processors of the UE to communicate with a core network over a 3GPP network, transmit a request to the core network for a PDU session including a request for data aggregation across the 3GPP network and a non-integrated IP network, receive a response from the core network granting the requested PDU session, the response including identification of a core network aggregation entity and an offload percentage, transmit data to the core network aggregation entity via the non-integrated IP network based on the offload percentage, and transmit data to the core network aggregation entity via the 3GPP network based on the offload percentage.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an example of wireless resources in an air interface utilizing orthogonal frequency divisional multiplexing (OFDM) according to some aspects.

FIG. 4 is a block diagram illustrating an example of a 5G wireless communication system according to some aspects.

FIG. 5 is a diagram illustrating an example of distributed entities in a wireless communication network according to some aspects.

FIG. 6 is a block diagram illustrating an example of a multiple access network configured for access traffic steering, switching, and splitting (ATSSS).

FIG. 7 is a block diagram illustrating an example of a multiple access network configured for non-integrated splitting/aggregation according to some aspects.

FIG. 8 is a block diagram illustrating an example of a multiple access network configured for non-integrated splitting/aggregation in a roaming architecture according to some aspects.

FIG. 9 is a conceptual illustration of two protocol stacks for a MASQUE proxy according to some aspects.

FIG. 10 is a table illustration comparing characteristics of a MPTCP proxy and a MASQUE proxy according to some aspects.

FIGS. 11-12 is a signaling diagram illustrating an example of establishing a protocol data unit (PDU) session with non-integrated aggregation for a multiple access network according to some aspects.

FIG. 13 is a table illustrating a parameter in a route selection descriptor for non-integrated WiFi aggregation according to some aspects.

FIG. 14 is an illustration of a parameter definition for a user equipment (UE) request for a PDU session with non-integrated aggregation according to some aspects.

FIG. 15 is an illustration of a parameter definition for a proxy address for a user plane function (UPF) associated with a protocol data unit (PDU) session with non-integrated aggregation according to some aspects.

FIG. 16 is an illustration of a parameter definition for a core network response to a UE request for a PDU session with non-integrated aggregation according to some aspects.

FIG. 17 is an illustration of a modified procedure for non-integrated aggregation (NIA) PDU establishment session according to some aspects.

FIG. 18 is a block diagram illustrating an example of a hardware implementation for a user equipment employing a processing system according to some aspects.

FIG. 19 is a flow chart illustrating an example method for communicating using non-integrated aggregation according to some aspects.

FIG. 20 is a block diagram illustrating an example of a hardware implementation for a network entity employing a processing system according to some aspects.

FIG. 21 is a flow chart illustrating an example method for communicating using non-integrated aggregation according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to multiple access networks with non-integrated aggregation. A UE may communicate with a core network over a 3rd Generation Partnership Project (3GPP) network, transmit a request to the core network for a protocol data unit (PDU) session including a request for data aggregation across the 3GPP network and a non-integrated internet protocol (IP) network, and receive a response from the core network granting the requested PDU session, the response including identification of a core network aggregation entity and an offload percentage. The UE may also transmit data to the core network aggregation entity via the non-integrated IP network based on the offload percentage, and transmit data to the core network aggregation entity via the 3GPP network based on the offload percentage.

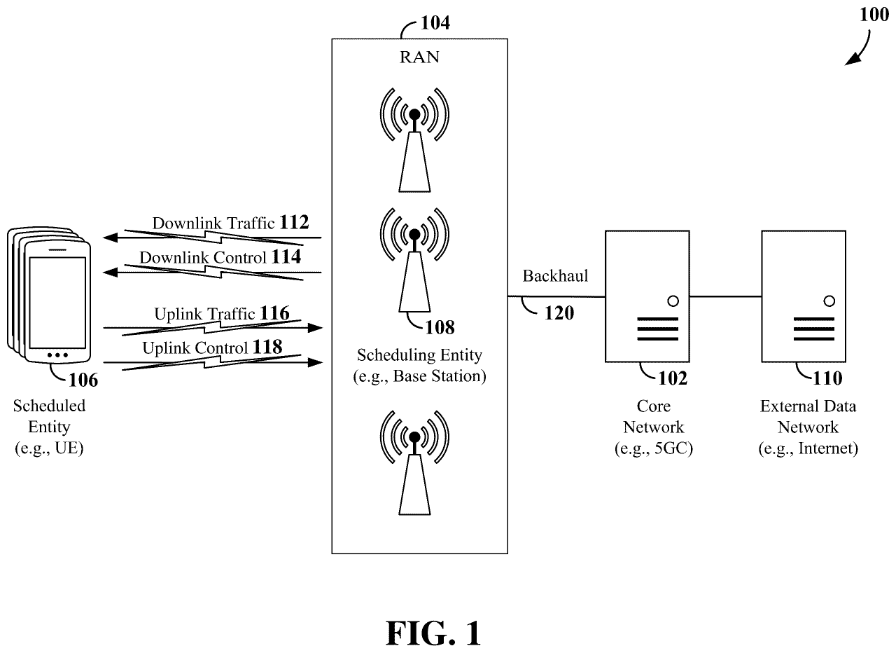

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

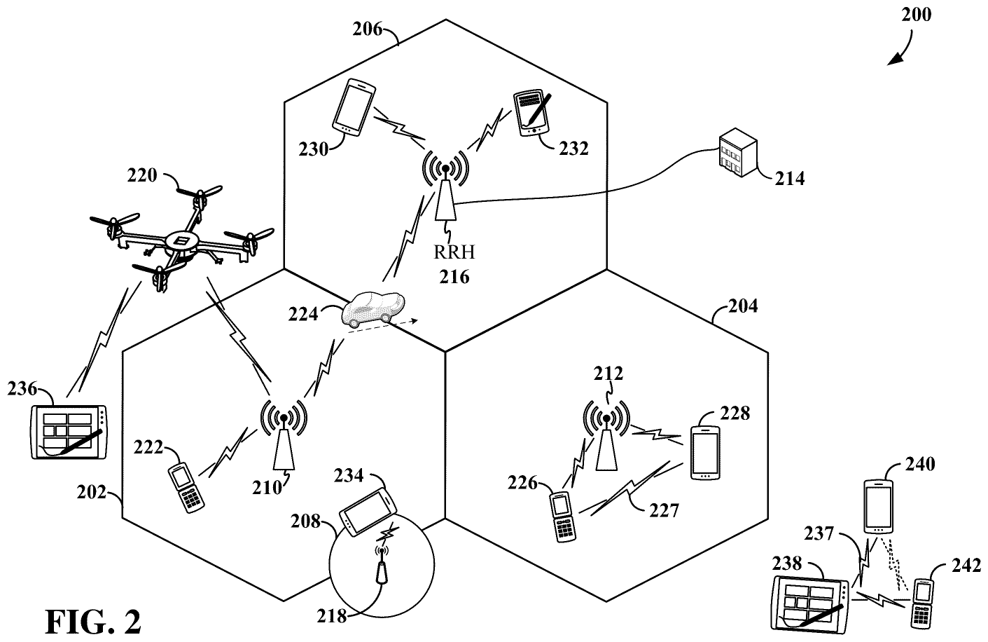

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

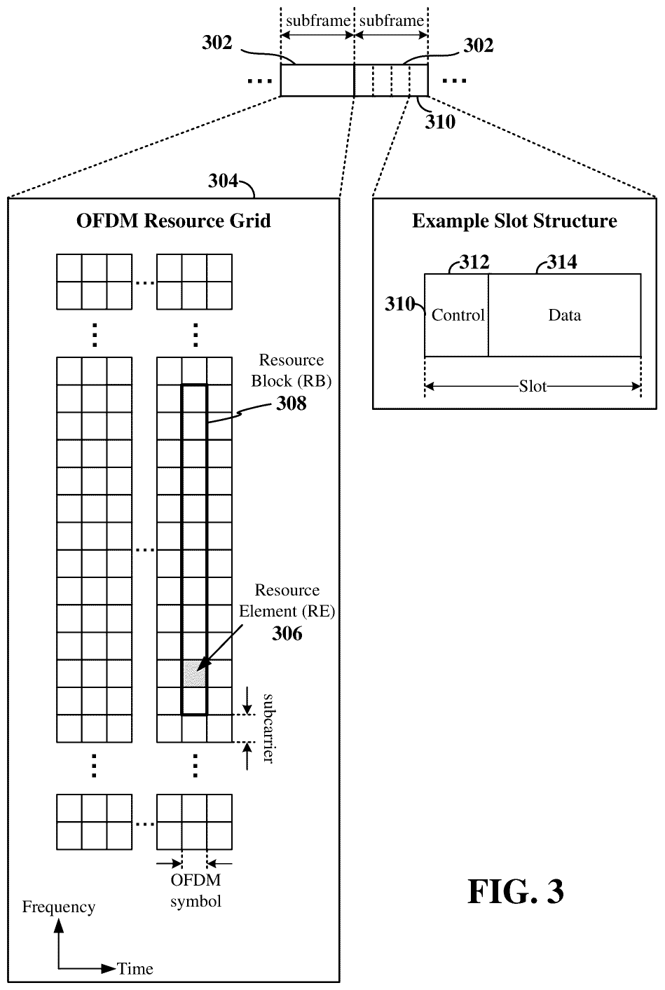

Various aspects of the present disclosure will be described with reference to an OFDM waveform, an example of which is schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an example subframe 302 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely an example, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-3 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

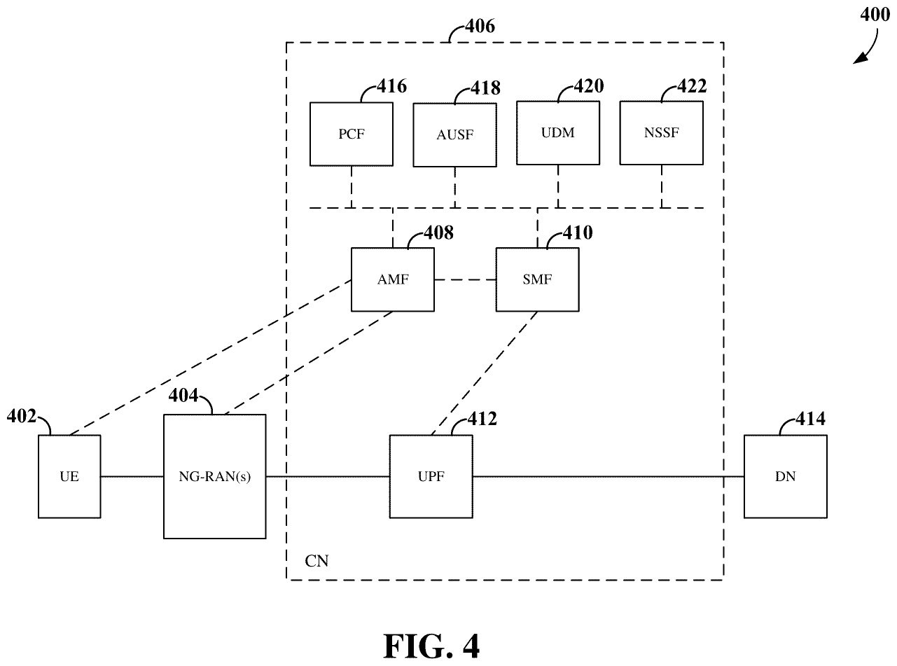

FIG. 4 illustrates an example of a 5G wireless communication system (5GS) 400. In some examples, the 5GS 400 may be the same wireless communication system 100 described above and illustrated in FIG. 1. The 5GS 400 includes a user equipment (UE) 402, a next generation radio access network (NG-RAN) 404, and a 5G core network 406. The UE 402 may correspond to any of the UEs or scheduled entities shown in any of FIGS. 1, 2, 4, 5, 6, 7, 9, 11, 12, 13, 14, 15, and 16. The NG-RAN 404 may correspond to any of the base stations or scheduling entities shown in any of FIGS. 1, 2, 4, 5, 9, 11, 12, 13, 14, 15, and 18.

The core network 406 may include, for example, an access and mobility management function (AMF) 408, a session management function (SMF) 410, and a user plane function (UPF) 412. The AMF 408 and the SMF 410 employ control plane (e.g., non-access stratum (NAS)) signaling to perform various functions related to mobility management and session management for the UE 402. For example, the AMF 408 provides connectivity, mobility management and authentication of the UE 402, while the SMF 410 provides session management of the UE 402 (e.g., processes signaling related to protocol data unit (PDU) sessions between the UE 402 and an external data network (DN) 414). The UPF 412 provides user plane connectivity to route 5G (NR) packets to/from the UE 402 via the NG-RAN 404.

The core network 406 may further include other functions, such as a policy control function (PCF) 416, authentication server function (AUSF) 418, unified data management (UDM) 420, network slice selection function (NSSF) 422, and other functions (not illustrated, for simplicity). The PCF 416 provides policy information (e.g., rules) for control plane functions, such as network slicing, roaming, and mobility management. In addition, the PCF 416 supports 5G quality of service (QOS) policies, network slice policies, and other types of policies. The AUSF 418 performs authentication of UEs 402. The UDM 420 facilitates the generation of authentication and key agreement (AKA) credentials, performs user identification and manages subscription information and UE context. In some examples, the AMF 408 includes a co-located security anchor function (SEAF) that allows for re-authentication of the UE 402 when the UE 402 moves between different NG-RANs 404 without having to perform a complete authentication process with the AUSF 418. The NSSF 422 redirects traffic to a network slice. Network slices may be defined, for example, for different classes of subscribers or use cases, such as smart home, Internet of Things (IoT), connected car, smart energy grid, etc. Each subscriber or use case may receive a unique set of optimized resources and network topology (e.g., a network slice) to meet the requirements (e.g., connectivity, speed, power, and/or capacity requirements) of the subscriber or use case.

To establish an NR SA connection to the 5G core network 406 via the NG-RAN 404, the UE 402 may transmit a registration request and a PDU session establishment request to the 5G core network 406 via the NG-RAN 404. The AMF 408 and the SMF 410 may process the registration request and the PDU session establishment request and establish a PDU session between the UE 402 and the external DN 414 via the UPF 412. A PDU session may include one or more sessions (e.g., data sessions or data flows) and may be served by multiple UPFs 412 (only one of which is shown for convenience). Examples of data flows include, but are not limited to, Internet Protocol (IP) flows, Ethernet flows, and unstructured data flows.

In some examples, a RAN may employ a distributed architecture where the functionality of a network node (e.g., incorporating modem functionality and/or other functionality) may be split among one or more control units and one or more distributed units (which may also be referred to as data units). For example, a network node may include one or more control units, each of which supports multiple distributed units. Each distributed unit may, in turn, support one or more radio units. A control unit, a distributed unit, and a radio unit provide different communication protocol layer functionality and other related functionality.

A network node may communicate with a core network via a backhaul link and communicate with at least one radio unit via at least one fronthaul link. In some examples, a network node may include at least one control unit and at least one distributed unit that communicate via at least one midhaul link.

In some examples, a control unit is a logical node that hosts a packet data convergence protocol (PDCP) layer, a radio resource control (RRC) layer, a service data adaptation protocol (SDAP) layer and other control functions. A control unit may also terminate interfaces (e.g., an E1 interface, an E2 interface, etc.) to network nodes (e.g., nodes of a core network). In addition, an F1 interface may provide a mechanism to interconnect a control unit (e.g., the PDCP layer and higher layers) and a distributed unit (e.g., the radio link control (RLC) layer and lower layers). In some aspects, an F1 interface may provide control plane and user plane functions (e.g., interface management, system information management, UE context management, RRC message transfer, etc.). For example, the F1 interface may support F1-C on the control plane and F1-U on the user plane. F1AP is an application protocol for F1 that defines signaling procedures for F1 in some examples.

In some examples, a distributed unit is a logical node that hosts an RLC layer, a medium access control (MAC) layer, and a high physical (PHY) layer based on a lower layer functional split. In some aspects, a distributed unit may control the operation of at least one radio unit. A distributed unit may also terminate interfaces (e.g., F1, E2, etc.) to the control unit and/or other network nodes. In some examples, a high PHY layer includes portions of the PHY processing such as forward error correction 1 (FEC 1) encoding and decoding, scrambling, modulation, and demodulation.

In some examples, a radio unit is a logical node that hosts low PHY layer and radio frequency (RF) processing based on a lower layer functional split. In some examples, a radio unit may be similar to a 3GPP transmit receive point (TRP) or remote radio head (RRH), while also including the low PHY layer. In some examples, a low PHY layer includes portions of the PHY processing such as fast Fourier transform (FFT), inverse FFT (iFFT), digital beamforming, and physical random access channel (PRACH) extraction and filtering. The radio unit may also include a radio chain for communicating with one or more UEs.

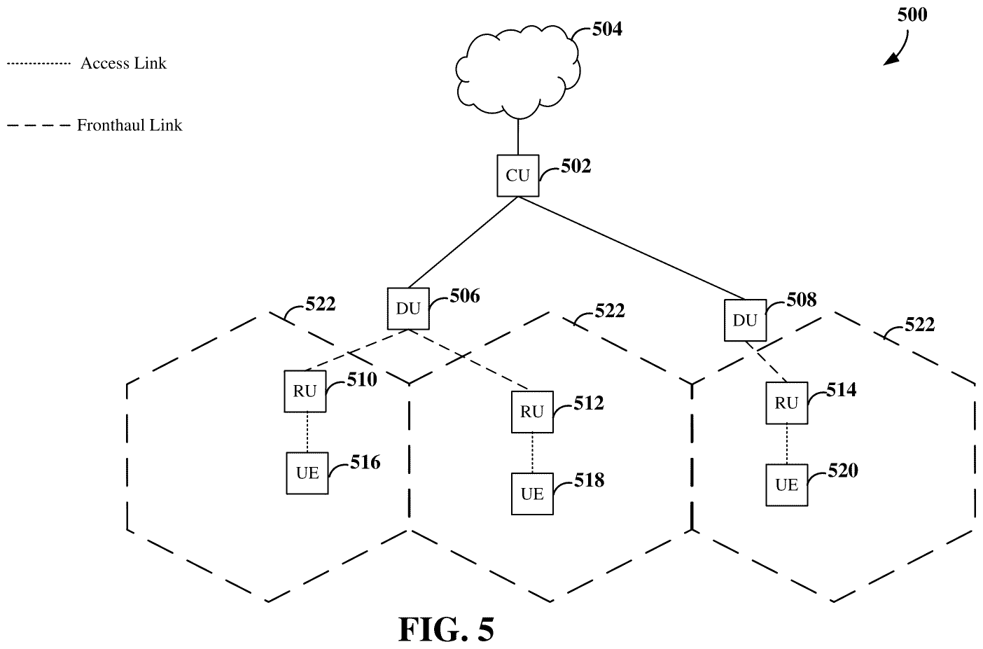

FIG. 5 is a diagram illustrating an example of a RAN 500 including distributed entities according to some aspects. The RAN 500 may be similar to the radio access network 200 shown in FIG. 2, in that the RAN 500 may be divided into a number of cells (e.g., cells 522) each of which may be served by respective network nodes (e.g., control units, distributed units, and radio units). The network nodes may constitute access points, base stations (BSs), eNBs, gNBs, or other nodes that utilize wireless spectrum (e.g., the radio frequency (RF) spectrum) and/or other communication links to support access for one or more UEs located within the cells.

In the example of FIG. 5, a control unit (CU) 502 communicates with a core network 504 via a backhaul link, and communicates with a first distributed unit (DU) 506 and a second distributed unit 508 via respective midhaul links. The first distributed unit 506 communicates with a first radio unit (RU) 510 and a second radio unit 512 via respective fronthaul links. The second distributed unit 508 communicates with a third radio unit 514 via a fronthaul link. The first radio unit 510 communicates with at least one UE 516 via at least one RF access link. The second radio unit 512 communicates with at least one UE 518 via at least one RF access link. The third radio unit 514 communicates with at least one UE 520 via at least one RF access link.

As discussed above, a UE may want to access data available via the core network. Traditionally this has been done using either a 3GPP access network (e.g., 5G RAN) or a non-3GPP access network (e.g., WiFi). In 5G, a UE can use multiple access networks (e.g., networks including both 5G RAN and WiFi) for data transfers but challenges for implementing and managing these features remain. One technique, access traffic steering, switching, and splitting (ATSSS), was introduced in Release 16 of the 3GPP specifications for allowing steering, switching, and splitting/aggregation of data traffic across multiple access networks. ATSSS provides for a multi-access protocol data unit (PDU) session for which data traffic at a UE can be served using one or more concurrent accesses (3GPP access (e.g., 5G NR), non-3GPP access (e.g., WiFi)).

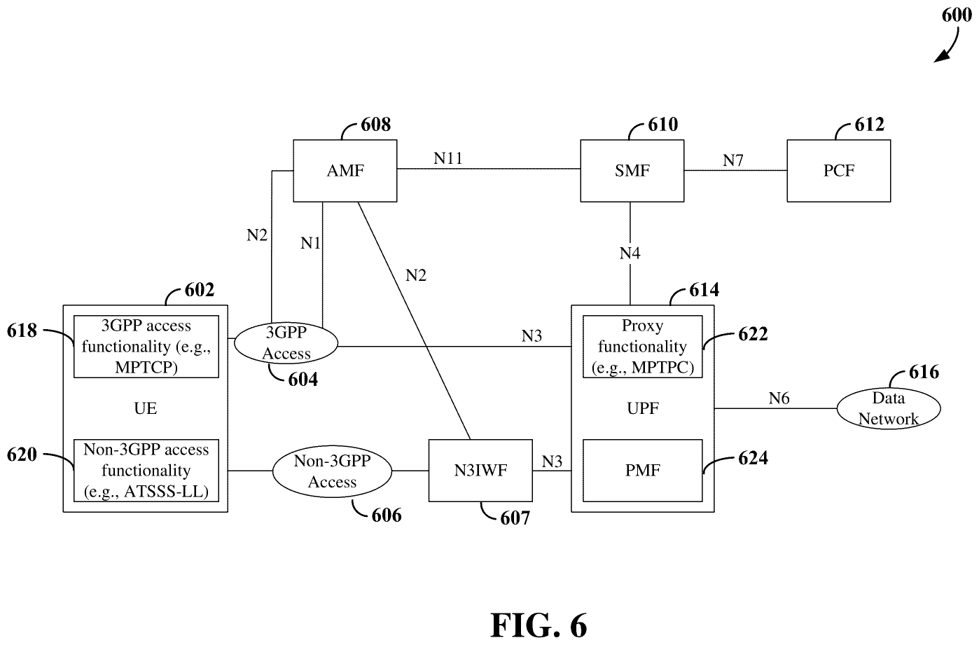

FIG. 6 is a block diagram illustrating an example of a multiple access network 600 configured for access traffic steering, switching, and splitting (ATSSS). The network 600 includes a user equipment (UE) 602, a 3GPP access node 604, a non-3GPP access node 606 (which includes a non-3GPP interworking function (N3IWF) 607), an AMF 608, an SMF 610, a PCF 612, and a UPF 614 that provides access to a DN 616. Example interfaces (N1, N2, N3, N4, N6, N7, and N11) used for communication among the various entities are also shown. In some examples, the UE 602 may correspond to any of the UEs or scheduled entities shown in any of FIGS. 1, 2, 4, and 5. In some examples, the 3GPP access node 604 may correspond to any of the base stations, scheduling entities, or DUs shown in any of FIGS. 1, 2, 4, and 5. In some examples, the AMF 608 may correspond to any of the AMF entities shown in any of FIGS. 4, 7, 8, 11, and 12. In some examples, the SMF 610 may correspond to any of the SMF entities shown in any of FIGS. 4, 7, 8, 11, and 12. In some examples, the PCF 612 may correspond to the PCF entities shown in any of FIGS. 4, 7, 8, 11, and 12. In some examples, the UPF 614 may correspond to any of the UPF entities shown in any of FIGS. 4, 7, 8, 11, and 12. In some examples, the DN 616 may correspond to any of the DN nodes shown in any of FIGS. 1, 2, 4, 7, 8, 11, and 12.

The UE 602 includes 3GPP access functionality (e.g., multipath transmission control protocol (MPTCP)) 618 for communicating with the 3GPP access node 604 and non-3GPP access functionality (e.g., access traffic steering, switching, and splitting lower layer (ATSSS-LL)) 620 for communicating with the non-3GPP access node 606. The UPF 614 includes proxy functionality 622 and a path management function (PMF) 624 for supporting the 3GPP access and the non-3GPP access. After the establishment of a PDU session, and when there are user-plane resources on all access networks, the UE 602 and the UPF 614 may apply network-provided policy and consider local conditions (e.g., network interface availability, signal loss conditions, user preferences, etc.) to decide how to distribute the UE traffic across the access networks.

As discussed above, the ATSSS functionality allows for a multi-access PDU session for which data traffic at a UE can be served using one or more concurrent accesses (3GPP access (e.g., 5G NR) 604, non-3GPP access (e.g., WiFi) 606/607). As it turns out, ATSSS has some downsides. First, ATSSS requires support for trusted or untrusted connectivity of integrated WiFi to the 5G core network (using trusted non-3GPP gateway function (TNGF) in the form of the N3IWF 607). As a result, many operators choose to rarely implement or deploy ATSSS. Second, the value of implementing N3IWF beyond support for voice over Wi-Fi is questionable. For example, if a wireless network operator deploys a N3IWF for general “internet access,” it will likely face hardware capacity issues due to several orders of magnitude of increasing traffic volume (e.g., from 20-50 kilobits per second (Kbps) per UE for voice over WiFi (VoWiFi) to possibly 100s of megabits per second (Mbps) for internet traffic), with a questionable return on investment. As a result, few operators and other industry professionals have shown interest in designing or deploying ATSSS.

Aspects of this disclosure relate to a multiple access network with non-integrated aggregation/splitting. In some examples, the multiple access network does not provide N3IWF support yet achieves some targets of ATSSS (e.g., traffic aggregation). In some examples, the disclosure provides for a multiple access network without the N3IWF, where a UE can send a request for a (non-integrated aggregation) PDU session including a request for data aggregation across a 3GPP network and a non-3GPP network (e.g., non-integrated IP network) to obtain identification of a core network aggregation entity (e.g., UPF) and an offload percentage. If the core network grants the request, the UE can send some data to the UPF via the non-integrated IP network based on the offload percentage, and send other data to the UPF via the 3GPP network based on the offload percentage. The UE and UPF may communicate over the non-integrated IP network using an agreed upon proxy that includes some method of encryption, thereby providing for a layer of security over the non-integrated network, which may otherwise be unsecure. The UE and UPF can communicate over the non-integrated IP network using IP addresses determined during the PDU session establishment. By using the non-integrated aggregation PDU session and associated configuration information, in some examples, this disclosure allows for some of the features of ATSSS without providing N3IWF support (e.g., use of the non-integrated IP network without the interworking function). In some examples and stated another way, the non-integrated IP network may be configured not to provide for control plane signaling with the core network (e.g., unlike the N3IWF).

In some examples, the non-integrated IP network is configured not to provide a non-3GPP interworking function (N3IWF). The functionality of N3IWF is defined in clause 6.2.9 of 3GPP TS 23.501 Release 16 which states:

The functionality of N3IWF in the case of untrusted non-3GPP access includes the following:
Support of IPsec tunnel establishment with the UE: The N3IWF terminates the IKEv2/IPsec protocols with the UE over NWu and relays over N2 the information needed to authenticate the UE and authorize its access to the 5G Core Network.
Termination of N2 and N3 interfaces to 5G Core Network for control-plane and user-plane respectively.
Relaying uplink and downlink control-plane NAS (N1) signalling between the UE and AMF.
Handling of N2 signalling from SMF (relayed by AMF) related to PDU Sessions and QoS.
Establishment of IPsec Security Association (IPsec SA) to support PDU Session traffic.
Relaying uplink and downlink user-plane packets between the UE and UPF. This involves:
   De-capsulation/encapsulation of packets for IPSec and N3 tunnelling
Enforcing QoS corresponding to N3 packet marking, taking into account QoS requirements associated to such marking received over N2
N3 user-plane packet marking in the uplink.
Local mobility anchor within untrusted non-3GPP access networks using MOBIKE per IETF RFC 4555 [57].
Supporting AMF selection.

In some examples, the non-integrated IP network is configured not to provide at least one of these N3IWF features. In some examples, the non-integrated IP network is configured not to provide any of these N3IWF features.

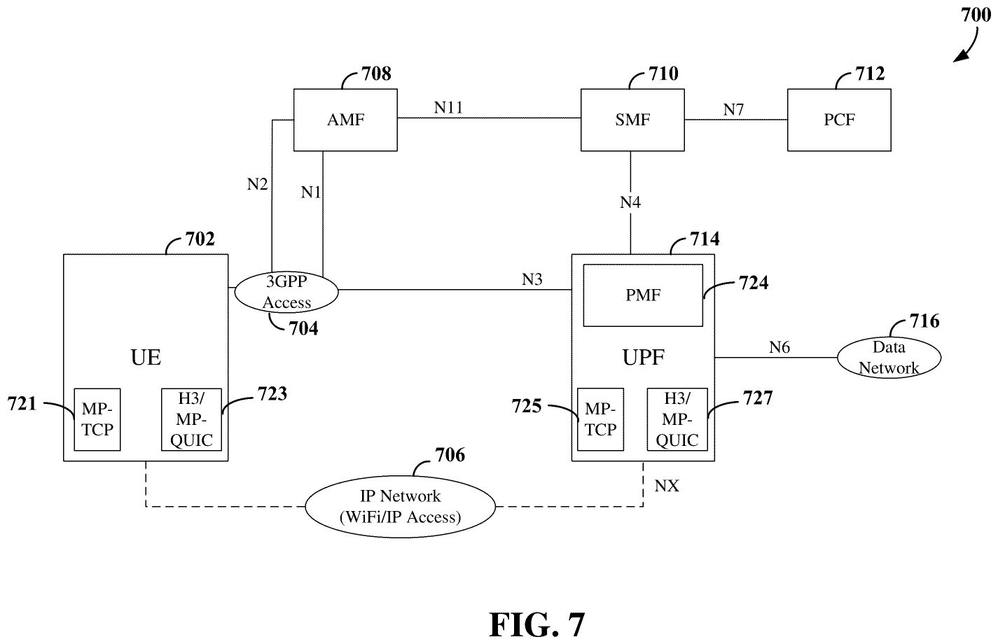

FIG. 7 is a block diagram illustrating an example of a multiple access network 700 configured for non-integrated splitting/aggregation according to some aspects. The network 700 includes a UE 702, a 3GPP access node 704, a non-3GPP access node (e.g., a non-integrated IP network providing WiFi and IP access) 706, an AMF 708, an SMF 710, a PCF 712, and a UPF 714 that provides access to a DN 716. Example interfaces (N1, N2, N3, N4, N6, N7, N11, and NX) used for communication among the various entities are also shown. In some examples, the UE 702 may correspond to any of the UEs or scheduled entities shown in any of FIGS. 1, 2, 4, 5, 6, 8, 11, 12, and 18. In some examples, the 3GPP access node 704 may correspond to any of the access nodes, base stations, scheduling entities, or DUs shown in any of FIGS. 1, 2, 4, 5, and 6. In some examples, the AMF 708 may correspond to any of the AMF entities shown in any of FIGS. 4, 6, 8, 11, and 12. In some examples, the SMF 710 may correspond to any of the SMF entities shown in any of FIGS. 4, 6, 8, 11, and 12. In some examples, the PCF 712 may correspond to any of the PCF entities shown in any of FIGS. 4, 6, 8, 11, and 12. In some examples, the UPF 714 may correspond to any of the UPF entities shown in any of FIGS. 4, 6, 8, 11, and 12. In some examples, the DN 716 may correspond to any of the DN nodes shown in any of FIGS. 1, 2, 4, 6, 8, 11, and 12.

The UE 702 includes 3GPP access functionality for communicating with the 3GPP access node/network 704 and non-3GPP access functionality for communicating with the non-3GPP access network (non-integrated IP network via NX) 706. The non-3GPP access network functionality at the UE 702 includes support for two proxy functions, namely MPTCP 721 and multipath QUIC (MP-QUIC) 723 for communicating over the non-integrated IP network/NX 706 with the UPF 714. The UPF 714 includes proxy functionality and a path management function (PMF) 724 for supporting the 3GPP access network and the non-3GPP access network (e.g., non-integrated IP network). More specifically, the non-3GPP access functionality at the UPF 714 includes support for two proxy functions, namely MPTCP 725 and MP-QUIC 727 for communicating over the non-integrated IP network/NX 706 with the UE 702.

As compared to the multiple access network 600 of FIG. 6, the multiple access network 700 does not include the N3IWF 607. Instead, non-3GPP access is provided by the non-integrated IP network 706 which is not integrated into the 3GPP access network and configured not to provide a non-3GPP interworking function (N3IWF). As a result, the non-integrated IP network 706 may be an unsecured WiFi network. Communications over the non-integrated IP network 706 may be made using any of the common proxies supported at both the UE and UPF. Each of the proxies may employ encryption to make communications more secure over the inherently unsecured non-integrated IP network 706. In some examples, the IP network 706 may be referred to as a non-integrated network in that it has no N1/N2 access to the core network (e.g., all components of FIG. 7 except the UE 702, 3GPP access 704, IP network 706, and data network 716; see also the core network 406 in FIG. 4) and does not support control plane signaling with the core network. In some examples, the IP network 706 does not support the interworking function(s) that the N3IWF 607 does. In some examples, the non-integrated IP network 706 is configured not to provide a non-3GPP interworking function (N3IWF).

In operation, the UE 702 may establish a connection to the core network, send a request for a non-integrated aggregation PDU session with a request for data aggregation across the across the 3GPP network 704 and the non-integrated IP network 706, receive a response from the core network granting the PDU session and including identification information for a core network aggregation entity (e.g., UPF 714) and an offload percentage. The UE 702 may then transmit data to the UPF 714 via the non-integrated IP network 706 based on the offload percentage, and may transmit data to the UPF 714 via the 3GPP network 704 based on the offload percentage. The identification information for the UPF 714 may include at least two network addresses, one for the N3 interface at the UPF 714 and one for the NX interface at the UPF 714. The identification information may also include a list of supported proxies at the UPF 714, including at least one proxy in common with the UE 702. Additional details of multiple access network operations including establishing PDU sessions, proxies, and other configuration details are provided below.

As to the proxies (e.g., MPTCP 725 and MPQUIC 727) at the UPF 714, they can have two network address (e.g., IP addresses), one for the N3 interface (e.g., core network interface) and one for the non-3GPP IP network (NX) interface. In contrast, the ATSSS implementation of FIG. 6 only uses one network address for the N3 interface. In some examples, the UE may use both network addresses to send data over the multiple access network via each of N3 and NX.

In some examples, the MP-QUIC proxy may also be referred to as a multiplexed application substrate over QUIC encryption (MASQUE) proxy. In some examples for the MASQUE proxy, the setup of this proxy at the UE 702 and UPF 714 is only performed over the N3 proxy link, using the N3 proxy network address at the UPF 714. In such case, the MPQUIC protocol itself can then handle the path IP addresses. In some examples, this is done because the NX interface/link is inherently not secure.

In the new architecture of FIG. 7, where the UPF 714 supports the unsecured NX interface using MPTCP, the MPTCP proxy may need to be secured against potential attacks (e.g., third party traffic). That is, in some instances, third party MPTCP traffic may attempt to misuse an unprotected MPTCP proxy over the NX interface. One possible solution to protect the MPTCP proxy is to only allow MP_CAPABLE SYN (e.g., defined by the Internet Engineering Task Force (IETF) and like transmission control protocol (TCP) defined SYN for establishing a connection between devices using TCP but for multipath TCP) over N3. In such case, the NX may only use MP_JOIN (e.g., defined by IETF for multipath TCP and used to identify the connection to be joined by the new subflow), and a new MPTCP connection is disallowed over NX, thereby setting up new sub flows to be allowed over NX. Another, and possibly better, solution only allows MP_CAPABLE SYN over N3, and does not allow SYN or even MP_JOIN on NX. To achieve this solution, the UE may send its NX IP address via ADD_ADDR (e.g., defined by IETF for multipath TCP to inform the other host about another potential address) on N3 to MPTCP proxy, and the server itself (UPF 714) then adds a new sub path. In such case, the MPTCP proxy server (at the UPF 714) can then reject all sub path requests over NX. As a result, the MPTCP proxy server (at the UPF 714) can be better protected. In some examples, once the NX interface link is setup, the UE and UPF may use TLS encryption over the NX link to provide some security.

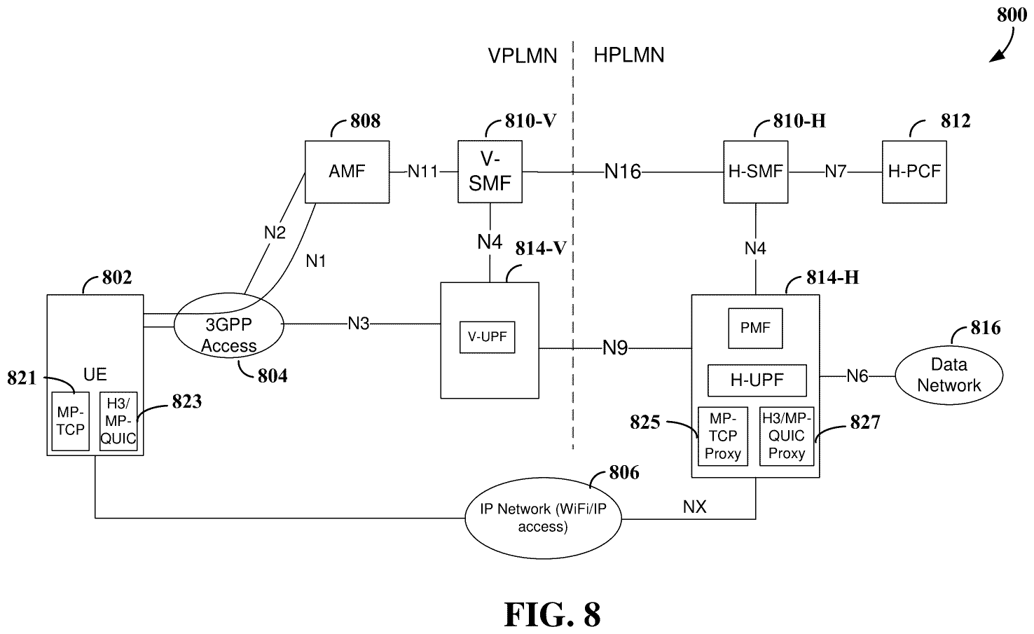

FIG. 8 is a block diagram illustrating an example of a multiple access network 800 configured for non-integrated splitting/aggregation in a roaming architecture according to some aspects. The roaming architecture includes two groups of core network access components, where one group is part of a home public land mobile network (HPLMN) and the other group is part of a visited public land mobile network (VPLMN). The network 800, as a whole, includes a UE 802, a 3GPP access node 804, a non-3GPP access node (e.g., non-integrated IP network providing WiFi and IP access) 806, an AMF 808, a V-SMF 810-V, an H-SMF 810-H, a PCF 812, a V-UPF 814-V, and an H-UPF 814 that provides access to a DN 816. Example interfaces (N1, N2, N3, N4, N6, N7, N9, N11, N16, and NX) used for communication among the various entities are also shown. In some examples, the UE 802 may correspond to any of the UEs or scheduled entities shown in any of FIGS. 1, 2, 4, 5, 6, 7, 11, 12, and 18.

In some examples, the 3GPP access node 804 may correspond to any of the access nodes, base stations, scheduling entities, or DUs shown in any of FIGS. 1, 2, 4, 5, 6 and 7. In some examples, the AMF 808 may correspond to any of the AMF entities shown in any of FIGS. 4, 6, 7, 11, and 12. In some examples, the V-SMF 810-V and/or H-SMF 810-H may correspond to any of the SMF entities shown in any of FIGS. 4, 6, 7, 11, and 12. In some examples, the PCF 812 may correspond to any of the PCF entities shown in any of FIGS. 4, 6, 7, 11, and 12. In some examples, the V-UPF 814-V and/or H-UPF 814-H may correspond to any of the UPF entities shown in any of FIGS. 4, 6, 7, 11, and 12. In some examples, the DN 816 may correspond to any of the DN nodes shown in any of FIGS. 1, 2, 4, 6, 8, 11, and 12. UE 802 includes support for two proxy functions, namely MPTCP 821 and MP-QUIC 823 for communicating over the non-3GPP access network/NX (e.g., non-integrated IP network or NX) 806 with the H-UPF 814-H. The H-UPF 814-H also include support for two proxy functions, namely MPTCP 825 and MP-QUIC 827 for communicating over the non-integrated IP network/NX 806 with the UE 802. In some examples, the MP-QUIC proxy may also be referred to as a multiplexed application substrate over QUIC encryption (MASQUE) proxy. In operation, the multiple access network 800 may operate similar to the multiple access network 700 of FIG. 7 except for the added components and links that make up the roaming architecture. As these components of the roaming architecture and their operation are known, this disclosure will not include further discussions of these components.

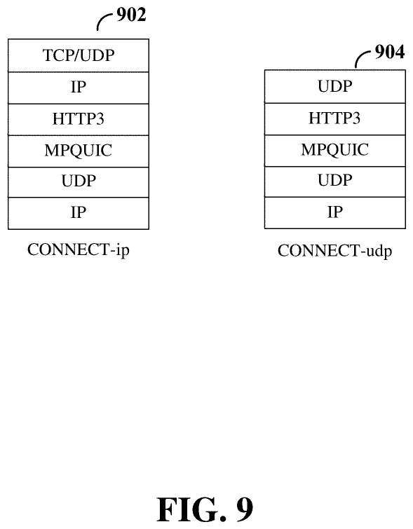

FIG. 9 is a conceptual illustration of two protocol stacks for a MASQUE proxy according to some aspects. A first of the two protocol stacks 902 can support MASQUE using IP (e.g., CONNECT-IP protocol for IP tunneling). The second protocol stack 904 can support MASQUE using UDP (e.g., CONNECT-UDP protocol for UDP tunneling). Both of these types of MASQUE proxies provide security using the MPQUIC encryption. These MASQUE proxies can be used by any of the UEs and UPFs described herein.

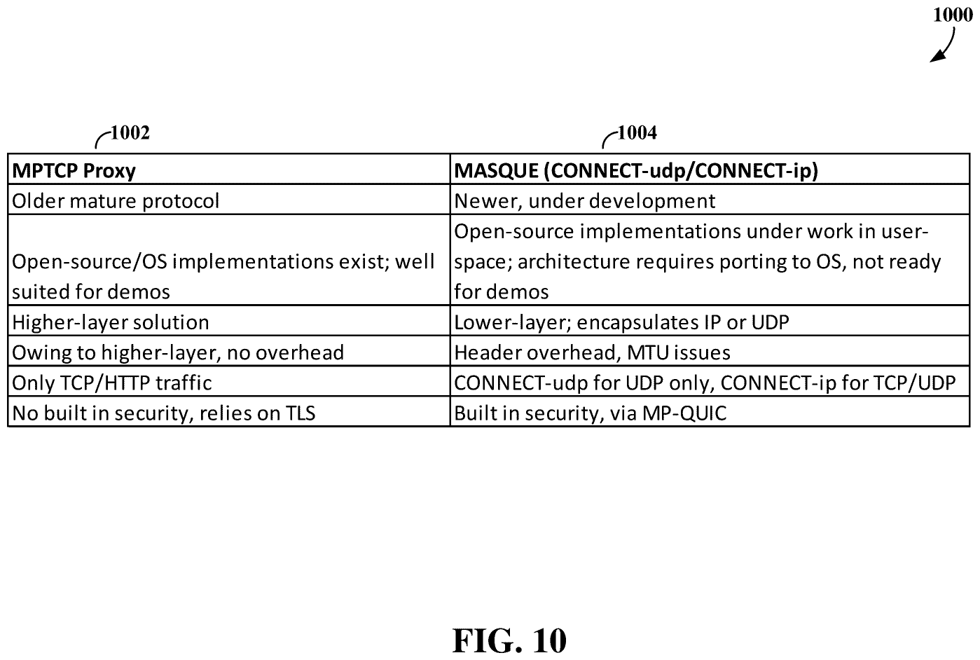

FIG. 10 is a table illustration comparing characteristics of a MPTCP proxy 1002 and a MASQUE proxy 1004 according to some aspects. Either of these proxy types can be used at any of the UEs or any of the UPFs described herein. For the MASQUE proxies, either of MASQUE using UDP or MASQUE using IP can be used.

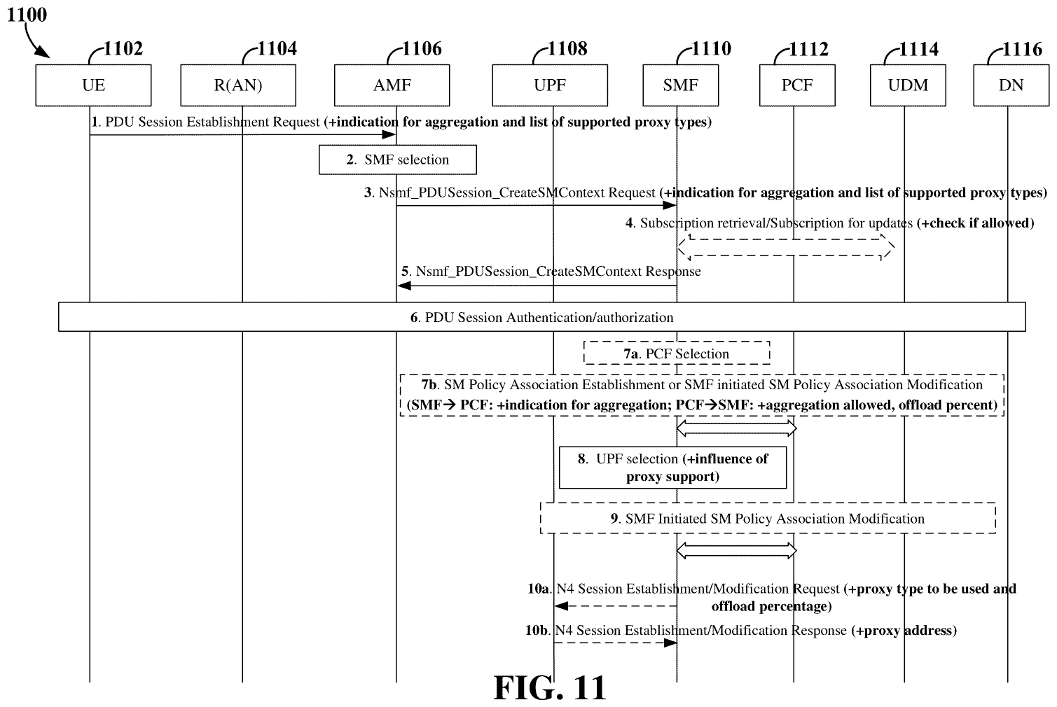

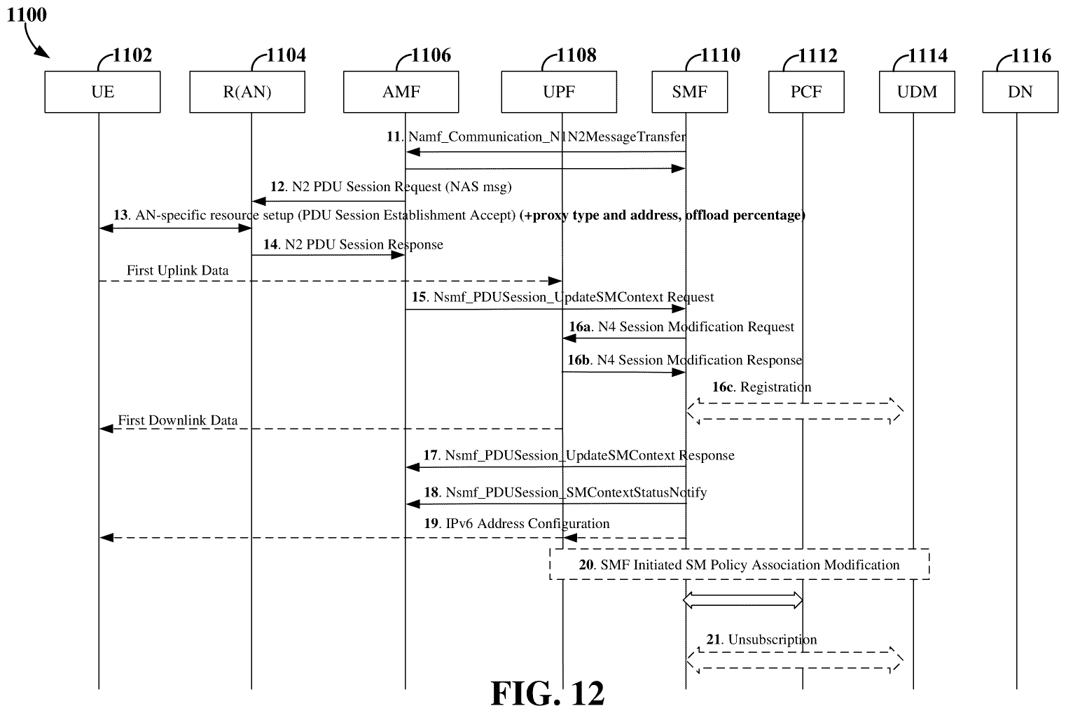

FIGS. 11-12 is a signaling diagram 1100 illustrating an example of establishing a protocol data unit (PDU) session with non-integrated aggregation for a multiple access network according to some aspects. The diagram includes a user equipment (UE) 1102, a radio access network (RAN) 1204, CN entities (an AMF 1206, a UPF 1108, an SMF 1110, a PCF 1112, a UDM 1114), and a DN 1116. In some examples, the UE 1102 may correspond to any of the UEs or scheduled entities shown in any of FIGS. 1, 2, 4-8, 12, and 18. In some examples, the RAN 1104 may correspond to any of the RAN nodes, CU nodes, or scheduling entities shown in any of FIGS. 1, 2, 4-8, and 12. In some examples, the AMF 1106 may correspond to any of the AMF entities shown in any of FIGS. 4, 6, 7, 8, and 12. In some examples, the UPF 1108 may correspond to any of the UPF entities shown in any of FIGS. 4, 6, 7, 8, and 12. In some examples, the SMF 1110 may correspond to any of the SMF entities shown in any of FIGS. 4, 6, 7, 8, and 12. In some examples, the PCF 1112 may correspond to any of the PCF entities shown in any of FIGS. 4, 6, 7, 8, and 12. In some examples, the UDM 1114 may correspond to any of the UDM entities shown in any of FIGS. 4 and 12. In some examples, the DN 1116 may correspond to any of the DN nodes shown in any of FIGS. 4, 6, 7, 8, and 12.

In some examples, the PDU establishment procedure of FIGS. 11-12 can be performed in accordance with 3GPP TS 25.502 Release 16, clause 4.3.2.2 which describes, among other things, a UE requested PDU session establishment and FIG. 4.3.2.2.1-1 (of 3GPP TS 25.502) that illustrates some of the actions of the signaling diagram of FIGS. 11-12. The signaling diagram of FIGS. 11-12 however illustrates new procedures that build on and modify the PDU establishment procedure of 3GPP TS 25.502 Release 16, clause 4.3.2.2.

At #1 of FIG. 11, the UE 1102 sends a PDU session establishment request to the AMF 1106. The request includes an indication or request for multiple access aggregation across a 3GPP network and a non-integrated IP network and a list of UE supported proxy types. In some examples, the request may be provided as a “NIA PDU request” in an uplink non-access stratum (NAS) transport (e.g., UL NAS Transport) message and with a list of its supported proxy types (MPTCP, UDP over HTTP3 (H3), IP over H3). In some examples, the “NIU PDU Request” Request Type in the UL NAS Transport message indicates to the network that this PDU Session Establishment Request is to establish a new NIA PDU Session and a UPF Proxy will aggregate the traffic.

In some examples, the UE may have already established a connection to the core network/AMF 1106 over the 3GPP network. The PDU request can further include other request information as specified in 3GPP TS 25.502 Release 16, clause 4.3.2.2. In some examples, the list of supported proxy types includes at least one UE supported proxy type. In some examples, the at least one UE supported proxy type may include one or more of a MPTCP proxy type (e.g., using TLS encryption), a MASQUE proxy type using UDP, or a MASQUE proxy type using IP. In some examples, the PDU session request may further include a UE requested offload percentage, where the offload percentage is indicative of a percentage of data traffic to be routed via the non-integrated IP network.

In some examples, the UE may obtain a suitable offload percentage, or other PDU session request parameters, in accordance with a UE route selection policy (URSP) specified by the core network. In some examples, the URSP can assist the UE with determining which user plane data resources to use for specific data types. In some examples, the URSP can be pre-configured by an operator or an original equipment manufacturer (OEM), configured by the core network at registration, or configured by the core network (e.g., by a PLMN or PCF) sometime after registration. In some examples, the URSP include rules for a given UE application as to whether it is allowed to perform multiple access aggregation using a non-integrated IP network, and in such case, a suitable offload percentage.

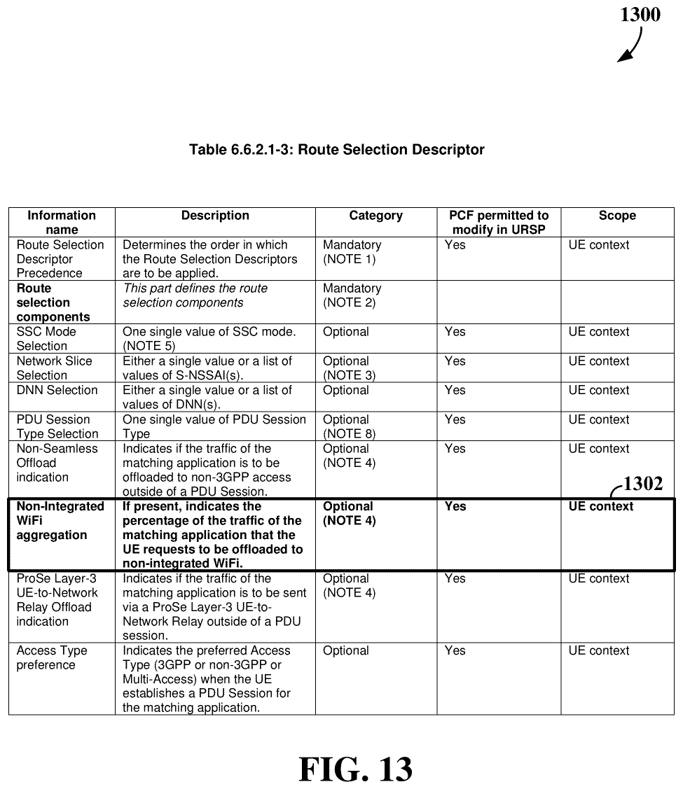

FIG. 13 is a table 1300 illustrating a parameter 1302 in a route selection descriptor for non-integrated WiFi aggregation according to some aspects. As noted in FIG. 13, the parameter 1302 may include a field for the offload percentage and a field indicating that the PCF may modify the parameter. This table may be used in conjunction with the URSP rules to specify certain parameters for UE route selection.

Returning to FIG. 11 and #1, in some examples, the PDU session request is sent in accordance with the URSP rules for a given application executing on the UE 1102. In such case, for the given application, it may request more than one PDU session. In some examples, for any one application executing on the UE, it may submit more than one PDU session request, but the offload percentage is made to be the same across all PDU session requests for that application, in accordance with the URSP rules for that application. In some examples, different applications executing on the UE 1102 may submit different PDU session requests and may have different offload percentages.

As described above, the UE 1102 may send the PDU session request along with the requested offload percentage and a list of the UE supported proxy types.

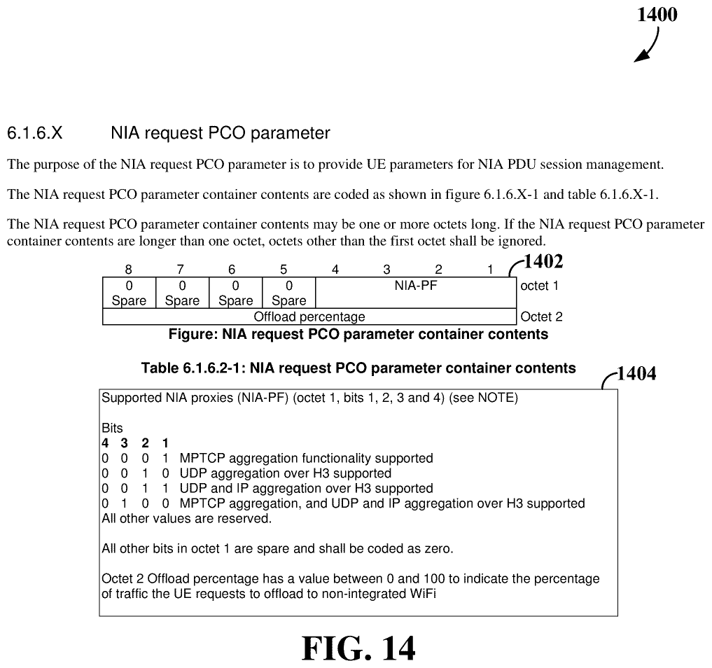

FIG. 14 is an illustration of a parameter definition for a user equipment (UE) request for a PDU session with non-integrated aggregation according to some aspects. The parameter definition is for a non-integrated aggregation (NIA) PDU session request with protocol control options (PCO). The illustration includes a first table 1402 showing a possible parameter configuration for specifying an offload percentage. The illustration further includes a second table 1404 showing a possible parameter configuration for specifying UE supported proxy types including bits to specify: (1) whether MPTCP aggregation functionality (e.g., MPTCP proxy) is supported, (2) whether UDP aggregation over H3 (e.g., MASQUE proxy via UDP) is supported, (3) whether UDP and IP aggregation over H3 (e.g., MASQUE proxy via IP) is supported, and (4) whether each of (1) and (3) is supported. In some examples, the request for the PDU session may thus include a UE requested offload percentage, whether the UE supports a MPTCP proxy type, whether the UE supports a MASQUE proxy type using UDP, and/or whether the UE supports a MASQUE proxy type using IP, and any combination of these. While tables 1402 and 1404 illustrate one implementation for specifying parameters for a UE requested NIA PDU session, other implementations are contemplated here as well.

In some examples, UE is configured to send the request for the NIA PDU session only over the 3GPP network. In such case, the setup and configuration of the unsecured non-3GPP network (e.g., the non-integrated IP network) is only performed over a secure integrated network (e.g., the 3GPP network).

Returning to FIG. 11, and at #2, the AMF 1106 can select an SMF 1110 to participate in the establishment of the requested PDU session.

At #3, the AMF 1106 sends a Nsmf_PDUSession_CreateSMContext Request to the SMF 1110 that includes the indication/request for multiple access aggregation and the list of UE supported proxy types. In some examples, this request can be sent in accordance with 3GPP TS 25.502 Release 16, clause 4.3.2.2. At #3, the AMF 1106 informs the SMF 1110 that the request is for an NIA PDU Session by including a “NIA PDU Request” indication.

At #4, the SMF 1110 retrieves, via Session Management subscription data, the information as to whether or not the NIA PDU session is allowed.

At #5, the SMF 1110 sends the Nsmf_PDUSession_CreateSMContext Response to the AMF 1106.

At #6, the core network (e.g., SMF 1110) may determine whether the PDU session is legitimate via an authentication procedure and authorizes it based on the authentication.

At #7a, the SMF 1110 may perform a PCF selection procedure to select PCF 1112.

At #7b, the SMF 1110 may perform a SM Policy Association Establishment or SMF initiated SM Policy Association Modification. In some examples, if dynamic policy control and charging (PCC) rules are to be used for the NIA PDU Session, the SMF 1110 may send an “NIA PDU Request” indication to the PCF 1112 in the SM Policy Control Create message (e.g., where the indication includes the UE request for aggregation). The PCF 1112 may decide whether the NIA PDU session is allowed or not based on operator policy and subscription data. The default PCC rules may contain the offload percentage.

At #8, the SMF 1110 selects a UPF 1108 for this PDU session. In some examples, the UPF selection (clause 6.3.3.3 of TS 23.501) considers the proxy capabilities of the UPF (e.g., selects a UPF that supports at least one of the UE supported proxies).

At #9, the SMF 1110 performs a SMF Initiated SM Policy Association Modification in accordance with clause 4.3.2.2.1 of TS 23.502.

At #10a, the SMF 1110 sends a N4 Session Establishment/Modification Request to the UPF 1108. In addition and at #10a, as part of the NIA PDU Session request, the SMF 1110 also sends the proxy type to be used, and the offload percentage of the NIA PDU session traffic to the UPF via the service data flow (SDF) template.

At #10b, the UPF 1108 sends a N4 Session Establishment/Modification Response to the SMF 1110. In addition and at #10b, the UPF 1108 sends the proxy address (e.g., proxy address of the UPF 1108 to be used by the UE 1102) to the SMF 1110.

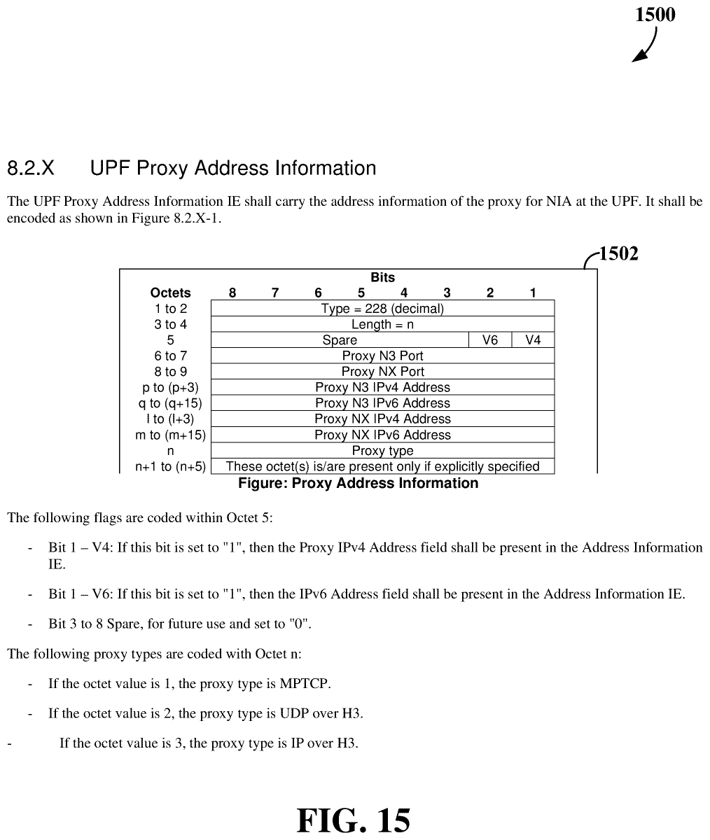

FIG. 15 is an illustration of a parameter definition 1500 for a proxy address for a UPF associated with a PDU session with non-integrated aggregation according to some aspects. The parameter includes a UPF Proxy Address Information information element (IE) that contains a specified number of octets for the IE. The IE contains the Proxy N3 Port, the Proxy NX Port, the Proxy N3 IPv4 Address, the Proxy N3 IPv6 Address, the Proxy NX IPv4 Address, the Proxy NX IPV6 Address, and Proxy type as shown in table 1502. In some examples, this parameter definition can be used by the UPF 1108 to send the proxy address(es) to the SMF at #10b in FIG. 11.

Returning now to FIG. 12 and at #11, the SMF 1110 sends a Namf_Communication_N1N2MessageTransfer message to the AMF 1106. In some examples, for the NIA PDU session, the SMF includes an “NIA PDU session Accepted” indication in the Namf_Communication_N1N2MessageTransfer message to the AMF 1106 and indicates to the AMF 1006 that the N2 SM Information included in this message should be sent over 3GPP access.

At #12, the AMF 1106 sends a N2 PDU Session Request (NAS msg) to the RAN 1104.

At #13, the RAN 1104 and UE 1102 perform an AN-specific resource setup (PDU Session Establishment Accept). At #13, the UE 1102 receives a PDU Session Establishment Accept message which indicates to UE 1102 that the requested NIA PDU session was successfully established. This message includes the proxy type and address information from the SMF 1110. In some examples, the message may include a NIA response policy control option (PCO) parameter. In some examples, the message may also include an offload percentage.

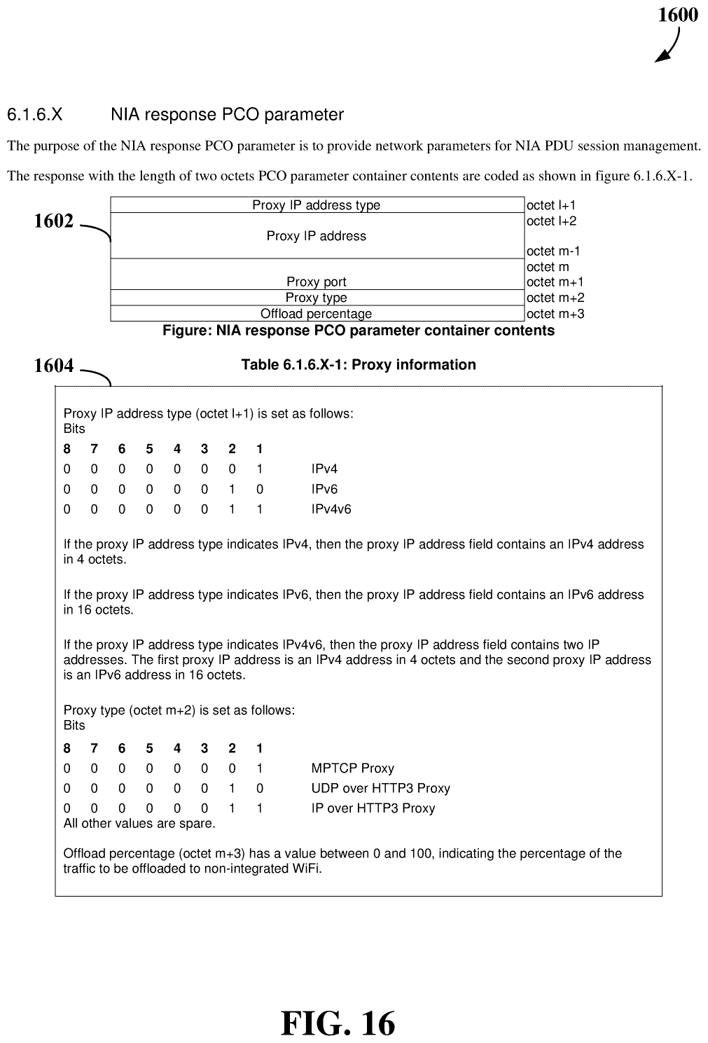

FIG. 16 is an illustration of a parameter definition 1600 for a core network response to a UE request for a PDU session with non-integrated aggregation (e.g., NIA Response PCO Parameter) according to some aspects. The parameter definition 1600 includes a table 1602 for a Proxy IP address type, a Proxy IP address (e.g., IP address of N3 or NX links), a Proxy port, a Proxy type, and an offload percentage. The parameter definition 1600 also includes a table 1604 that describes or enumerates various Proxy IP address types (e.g., IPv4, IPv6, IPv4v6) that could be used in table 1602. Table 1604 also describes or enumerates Proxy types (e.g., MPTCP Proxy, UDP over HTTP3 Proxy, IP over HTTP3 Proxy) that could be used in table 1602. Table 1604 also specifies that the offload percentage may be a value between 0 and 100. In some examples, the message the UE 1102 receives in #13 of FIG. 12 may implement the message format of parameter definition 1600. While tables 1602 and 1604 illustrate one implementation for specifying parameters for a core network response to the UE requested NIA PDU session, other implementations are contemplated here as well.

Returning to FIG. 12 and #13, the UE 1102 may receive a response from the core network granting the requested NIA PDU session, the response (e.g., like NIA response PCO parameter 16 of FIG. 16) including identification of the core network aggregation entity (e.g., selected UPF and IP addresses thereof for N3 and NX interfaces) and an offload percentage.

In some examples, there is no PMF functionality for a NIA PDU session.

At each of #14 through #21, the NIA PDU establishment session can be performed in accordance with clause 4.3.2.2.1 of TS 23.502.

In some examples, the NIA PDU establishment session procedures can be extended to a home-routed roaming case. In some examples, the procedures involving SMF, PCF, and the UPF are performed by H-SMF using N16 H-PCF and the H-UPF using the N9 interfaces respectively.

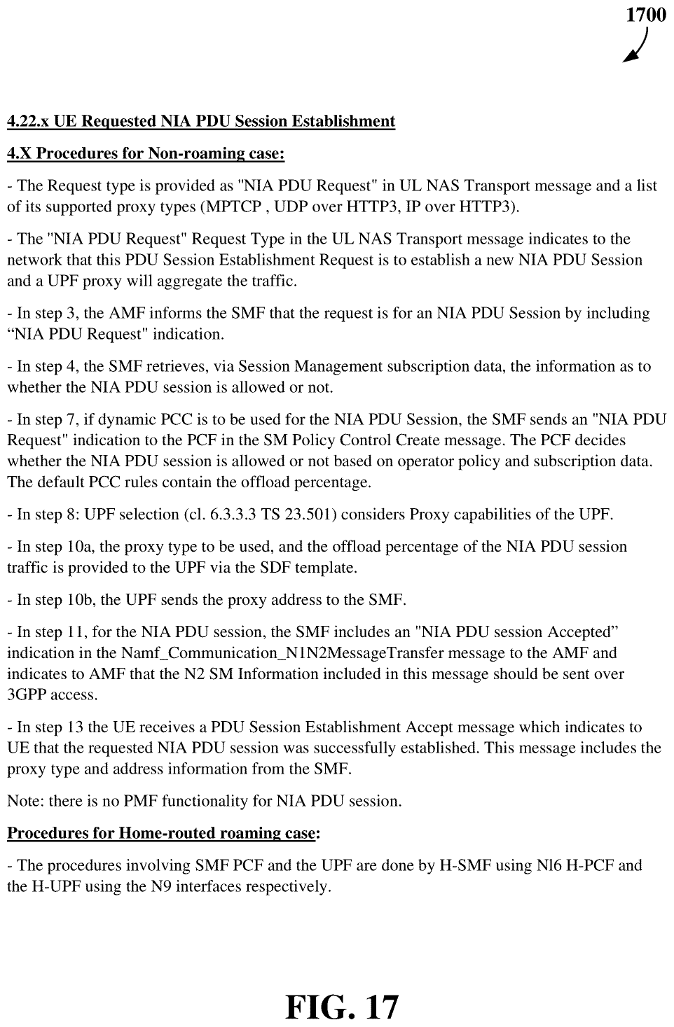

FIG. 17 is an illustration of a modified procedure 1700 for a non-integrated aggregation (NIA) PDU establishment session according to some aspects. In some examples, modified procedure 1700 may illustrate and highlight the changes in the PDU session establishment procedure for clause 4.3.2.2.1 of TS 23.502 used to instead provide the non-integrated aggregation (NIA) PDU establishment session described herein. These changes were described above in the discussion of the signaling diagram of FIGS. 11 and 12, and are shown in FIG. 17 to highlight them.

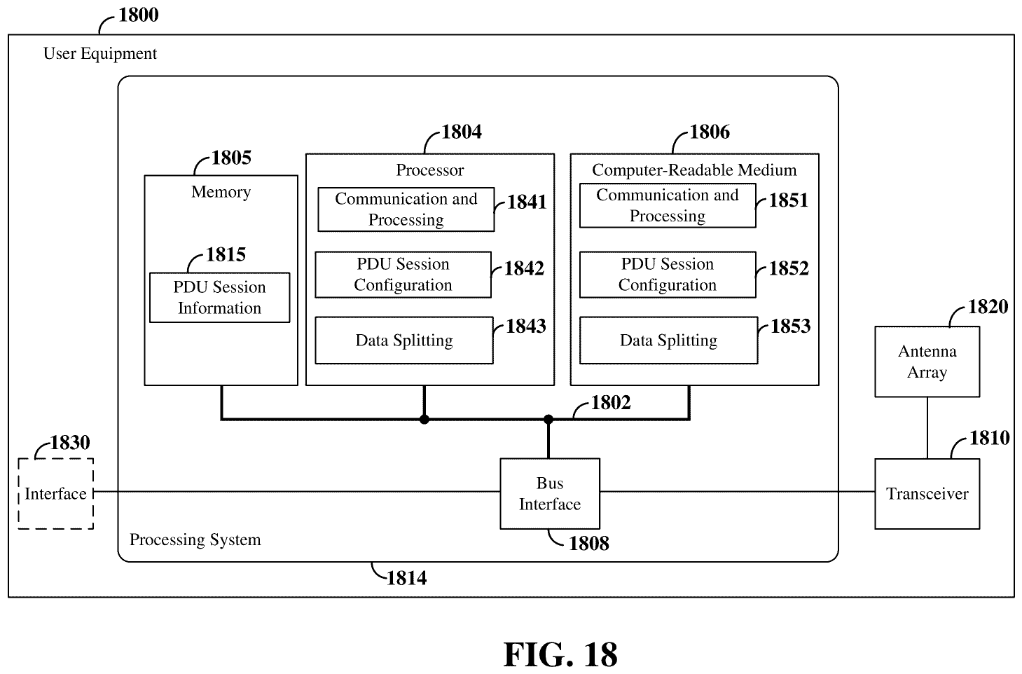

FIG. 18 is a block diagram illustrating an example of a hardware implementation for a user equipment employing a processing system according to some aspects. For example, the UE 1800 may be a device configured to wirelessly communicate with a base station, as discussed in any one or more of FIGS. 1-17. In some implementations, the UE 1800 may correspond to any of the UEs or scheduled entities shown in any of FIGS. 1, 2, 4, 5, 6, 7, 8, 11, and 12.

In accordance with various aspects of the disclosure, an element, or any portion of an element, or any combination of elements may be implemented with the processing system 1814. The processing system 1814 may include one or more processors 1804. Examples of processors 1804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1800 may be configured to perform any one or more of the functions described herein. That is, the processor 1804, as utilized in a UE 1800, may be used to implement any one or more of the processes and procedures described herein.

The processor 1804 may in some instances be implemented via a baseband or modem chip and in other implementations, the processor 1804 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1814 may be implemented with a bus architecture, represented generally by the bus 1802. The bus 1802 may include any number of interconnecting buses and bridges depending on the specific application of the processing system 1814 and the overall design constraints. The bus 1802 communicatively couples together various circuits including one or more processors (represented generally by the processor 1804), a memory 1805, and computer-readable media (represented generally by the computer-readable medium 1806). The bus 1802 may also link various other circuits such as timing sources, peripherals, voltage regulators, and power management circuits, which are well known in the art, and therefore, will not be described any further. A bus interface 1808 provides an interface between the bus 1802 and a transceiver 1810 and between the bus 1802 and an interface 1830. The transceiver 1810 provides a communication interface or means for communicating with various other apparatus over a wireless transmission medium. In some examples, the UE may include two or more transceivers 1810. The interface 1830 provides a communication interface or means of communicating with various other apparatuses and devices (e.g., other devices housed within the same apparatus as the UE or other external apparatuses) over an internal bus or external transmission medium, such as an Ethernet cable. Depending upon the nature of the apparatus, the interface 1830 may include a user interface (e.g., keypad, display, speaker, microphone, joystick). Of course, such a user interface is optional, and may be omitted in some examples, such as an IoT device.

The processor 1804 is responsible for managing the bus 1802 and general processing, including the execution of software stored on the computer-readable medium 1806. The software, when executed by the processor 1804, causes the processing system 1814 to perform the various functions described below for any particular apparatus. The computer-readable medium 1806 and the memory 1805 may also be used for storing data that is manipulated by the processor 1804 when executing software. For example, the memory 1805 may include PDU session information 1815 used by the processor 1804 in cooperation with the transceiver 1810 for transmitting and/or receiving data associated with a PDU session or data splitting.

One or more processors 1804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1806.

The computer-readable medium 1806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1806 may reside in the processing system 1814, external to the processing system 1814, or distributed across multiple entities including the processing system 1814. The computer-readable medium 1806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

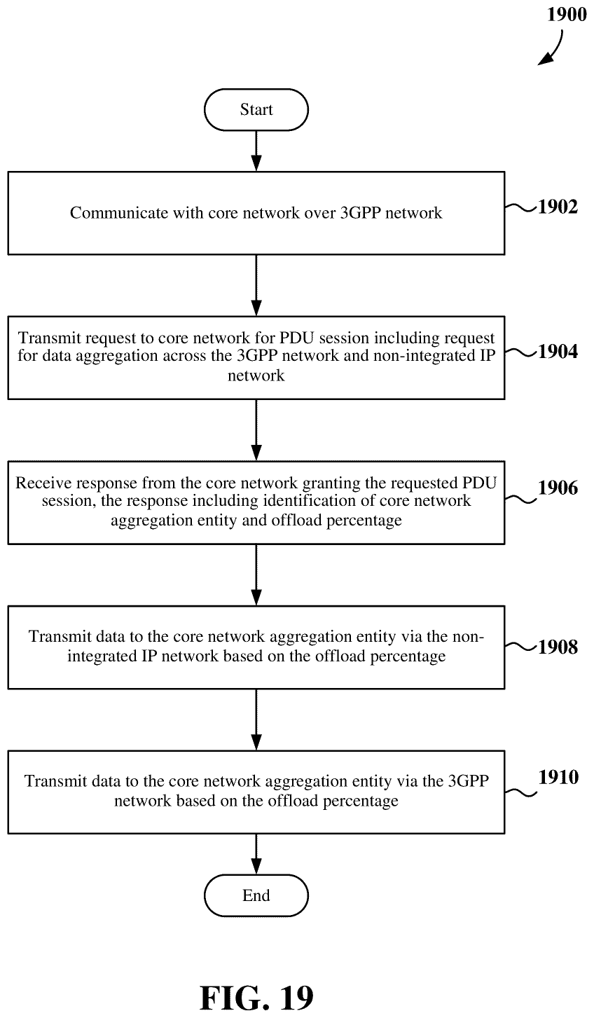

The UE 1800 may be configured to perform any one or more of the operations described herein (e.g., as described above in conjunction with FIGS. 1-17 and as described below in conjunction with FIG. 19). In some aspects of the disclosure, the processor 1804, as utilized in the UE 1800, may include circuitry configured for various functions.

The processor 1804 may include communication and processing circuitry 1841. The communication and processing circuitry 1841 may be configured to communicate with a base station, such as a gNB, and/or a core network entity, such as a UPF (e.g., via an IP network). The communication and processing circuitry 1841 may include one or more hardware components that provide the physical structure that performs various processes related to wireless communication (e.g., signal reception and/or signal transmission) as described herein. The communication and processing circuitry 1841 may further include one or more hardware components that provide the physical structure that performs various processes related to signal processing (e.g., processing a received signal and/or processing a signal for transmission) as described herein. In some examples, the communication and processing circuitry 1841 may include two or more transmit/receive chains, each configured to process signals in a different RAT (or RAN) type. The communication and processing circuitry 1841 may further be configured to execute communication and processing software 1851 included on the computer-readable medium 1806 to implement one or more functions described herein.

In some implementations where the communication involves receiving information, the communication and processing circuitry 1841 may obtain information from a component of the UE 1800 (e.g., from the transceiver 1810 that receives the information via radio frequency signaling or some other type of signaling suitable for the applicable communication medium), process (e.g., decode) the information, and output the processed information. For example, the communication and processing circuitry 1841 may output the information to another component of the processor 1804, to the memory 1805, or to the bus interface 1808. In some examples, the communication and processing circuitry 1841 may receive one or more of signals, messages, other information, or any combination thereof. In some examples, the communication and processing circuitry 1841 may receive information via one or more channels. In some examples, the communication and processing circuitry 1841 may include functionality for a means for receiving. In some examples, the communication and processing circuitry 1841 may include functionality for a means for decoding.

In some implementations where the communication involves sending (e.g., transmitting) information, the communication and processing circuitry 1841 may obtain information (e.g., from another component of the processor 1804, the memory 1805, or the bus interface 1808), process (e.g., encode) the information, and output the processed information. For example, the communication and processing circuitry 1841 may output the information to the transceiver 1810 (e.g., that transmits the information via radio frequency signaling or some other type of signaling suitable for the applicable communication medium). In some examples, the communication and processing circuitry 1841 may send one or more of signals, messages, other information, or any combination thereof. In some examples, the communication and processing circuitry 1841 may send information via one or more channels. In some examples, the communication and processing circuitry 1841 may include functionality for a means for sending (e.g., a means for transmitting). In some examples, the communication and processing circuitry 1841 may include functionality for a means for encoding.

The processor 1804 may include communication and processing circuitry 1841 configured to establish communications with a core network over a 3GPP network (e.g., one or more of the operations described in conjunction with FIGS. 7-17, 19). The communication and processing circuitry 1841 may be configured to execute communication and processing software 1852 included on the computer-readable medium 1806 to implement one or more functions described herein.

The communication and processing circuitry 1841 may include functionality for a means for communicating with a core network over a 3GPP network (e.g., as described in conjunction with block 1902 of FIG. 19). For example, the UE may establish communications with the 3GPP network (e.g., a 5G network).

The processor 1804 may include PDU session configuration circuitry 1842 configured to perform PDU session configuration-related operations as discussed herein (e.g., one or more of the operations described in conjunction with FIGS. 7-17, 19). The PDU session configuration circuitry 1842 may be configured to execute PDU session configuration software 1852 included on the computer-readable medium 1806 to implement one or more functions described herein.

The PDU session configuration circuitry 1842 may include functionality for a means for transmitting a request to a core network for a PDU session including a request for data aggregation across a 3GPP network and a non-integrated IP network (e.g., as described in conjunction with #1 of FIG. 11, FIG. 14, and/or block 1904 of FIG. 19). For example, the PDU session configuration circuitry 1842 may be configured to transmit a request to a core network for a PDU session including a request for data aggregation across the 3GPP network (e.g., 5G network) and a non-integrated IP network (e.g., WiFi network).

The PDU session configuration circuitry 1842 may include functionality for a means for receiving a response from a core network granting a requested PDU session, the response including identification of a core network aggregation entity and an offload percentage (e.g., as described in conjunction with #13 of FIG. 12, FIG. 16, and/or block 1906 of FIG. 19). For example, the PDU session configuration circuitry 1842 may be configured to receive a response from a core network granting a requested PDU session, the response including identification of a core network aggregation entity (e.g., network address of UPF) and an offload percentage.

The processor 1804 may include data splitting circuitry 1843 configured to perform data splitting/aggregation-related operations as discussed herein (e.g., one or more of the operations described in conjunction with FIGS. 7-17). The data splitting circuitry 1843 may be configured to execute data splitting software 1853 included on the computer-readable medium 1806 to implement one or more functions described herein.

The data splitting circuitry 1843 may include functionality for a means for transmitting data to a core network aggregation entity via a non-integrated IP network based on an offload percentage (e.g., as described in conjunction with block 1908 of FIG. 19). For example, the data splitting circuitry 1843 may be configured to transmit data to a core network aggregation entity (e.g., a UPF) via a non-integrated IP network based on an offload percentage.

The data splitting circuitry 1843 may include functionality for a means for transmitting data to a core network aggregation entity via a 3GPP network based on an offload percentage (e.g., as described in conjunction with block 1910 of FIG. 19). For example, the data splitting circuitry 1843 may be configured to transmit data to the core network aggregation entity via the 3GPP network (e.g., 5G network) based on the offload percentage.

FIG. 19 is a flow chart illustrating an example method 1900 for wireless communication according to some aspects of the disclosure. As described herein, some or all illustrated features may be omitted in a particular implementation within the scope of the present disclosure, and some illustrated features may not be required for implementation of all examples. In some examples, the method 1900 may be carried out by the UE 1800 illustrated in FIG. 18. In some examples, the method 1900 may be carried out by any suitable apparatus or means for carrying out the functions or algorithm described below.

At block 1902, a user equipment may communicate with a core network over a 3GPP network. For example, the communication and processing circuitry 1841 and the transceiver 1810, shown and described above in connection with FIG. 18, may provide a means to communicate with a core network over a 3GPP network.

At block 1904, a user equipment may transmit a request to the core network for a PDU session including a request for data aggregation across the 3GPP network and a non-integrated IP network. For example, the PDU session circuitry 1842 and the transceiver 1810, shown and described above in connection with FIG. 18, may provide a means to transmit a request to the core network for a PDU session including a request for data aggregation across the 3GPP network and a non-integrated IP network.

At block 1906, a user equipment may receive a response from the core network granting the requested PDU session, the response including identification of a core network aggregation entity and an offload percentage. For example, the PDU session circuitry 1842 and the transceiver 1810, shown and described above in connection with FIG. 18, may provide a means to receive a response from the core network granting the requested PDU session, the response including identification of a core network aggregation entity and an offload percentage.

At block 1908, a user equipment may transmit data to the core network aggregation entity via the non-integrated IP network based on the offload percentage. For example, the data splitting circuitry 1843 and the transceiver 1810, shown and described above in connection with FIG. 18, may provide a means to transmit data to the core network aggregation entity via the non-integrated IP network based on the offload percentage.

At block 1910, a user equipment may transmit data, via the transceiver, to the core network aggregation entity via the 3GPP network based on the offload percentage. For example, the data splitting circuitry 1843 and the transceiver 1810, shown and described above in connection with FIG. 18, may provide a means to transmit data, via the transceiver, to the core network aggregation entity via the 3GPP network based on the offload percentage.

In some examples, the non-integrated IP network includes a WiFi network, and the 3GPP network includes a 5G network.

In some examples, the core network aggregation entity includes a user plane function (UPF) device.

In some examples, the UE includes at least one application configured to execute on the UE, the UE is configured to transmit, from the at least one application, the request to the core network for the PDU session, and the UE is configured to transmit data, from the at least one application, to the core network aggregation entity via the non-integrated IP network based on the offload percentage.

In some examples, the UE may receive a UE Route Selection Policy (URSP), and the UE may transmit the request to the core network for the PDU session based on the URSP.

In some examples, the request to the core network for the PDU session further includes an indication of a requested offload percentage, whether the UE supports a multipath transmission control protocol (MPTCP) proxy type, whether the UE supports a multiplexed application substrate over QUIC (MASQUE) proxy type using user datagram protocol (UDP), and whether the UE supports a MASQUE proxy type using internet protocol (IP).

In some examples, the response from the core network granting the requested PDU session further includes an indication of a granted offload percentage, whether the core network aggregation entity supports a multipath transmission control protocol (MPTCP) proxy type, whether the core network aggregation entity supports a multiplexed application substrate over QUIC (MASQUE) proxy type using user datagram protocol (UDP), and whether the core network aggregation entity supports a MASQUE proxy type using internet protocol (IP).

In some examples, the response from the core network granting the requested PDU session further includes a network address for the core network aggregation entity for each of the 3GPP network and the non-integrated IP network, and the response from the core network granting the requested PDU session further includes an indication of an IP address type of the network address for the core network aggregation entity for each of the 3GPP network and the non-integrated IP network.

In some examples, the UE may transmit the request to the core network for the PDU session via the 3GPP network (e.g., only via the 3GPP network), and the UE may receive the response from the core network granting the requested PDU session via the 3GPP network (e.g., only via the 3GPP network).

In some examples, the non-integrated IP network is configured not to provide a non-3GPP interworking function (N3IWF).

In some examples, the request to the core network for the PDU session further includes at least one UE supported proxy type, the response from the core network granting the requested PDU session includes at least one supported proxy type for the core network aggregation entity, including the UE supported proxy type, and the UE may transmit data, using a proxy type supported by both the UE and the core network aggregation entity, to the core network aggregation entity via the non-integrated IP network based on the offload percentage.

In some examples, the response from the core network granting the requested PDU session further includes a network address for the core network aggregation entity for each of the 3GPP network and the non-integrated IP network, and the UE may transmit data, using a proxy type supported by both the UE and the core network aggregation entity, to the core network aggregation entity using the network address of the non-integrated IP network in accordance with the offload percentage.

In some examples, the at least one UE supported proxy type includes at least one of a multipath transmission control protocol (MPTCP) proxy type, a multiplexed application substrate over QUIC (MASQUE) proxy type using user datagram protocol (UDP), or a MASQUE proxy type using internet protocol (IP), and the at least one supported proxy type for the core network aggregation entity includes at least one of a MPTCP proxy type, a MASQUE proxy type using UDP, or a MASQUE proxy type using IP.

In some examples, the at least one supported proxy type includes a multipath transmission control protocol (MPTCP) proxy type, and the UE may transmit data, using the MPTCP proxy type and encryption provided by transport layer security (TLS), to the core network aggregation entity via the non-integrated IP network based on the offload percentage.

In some examples, the offload percentage is indicative of a percentage of data traffic to be routed via the non-integrated IP network.

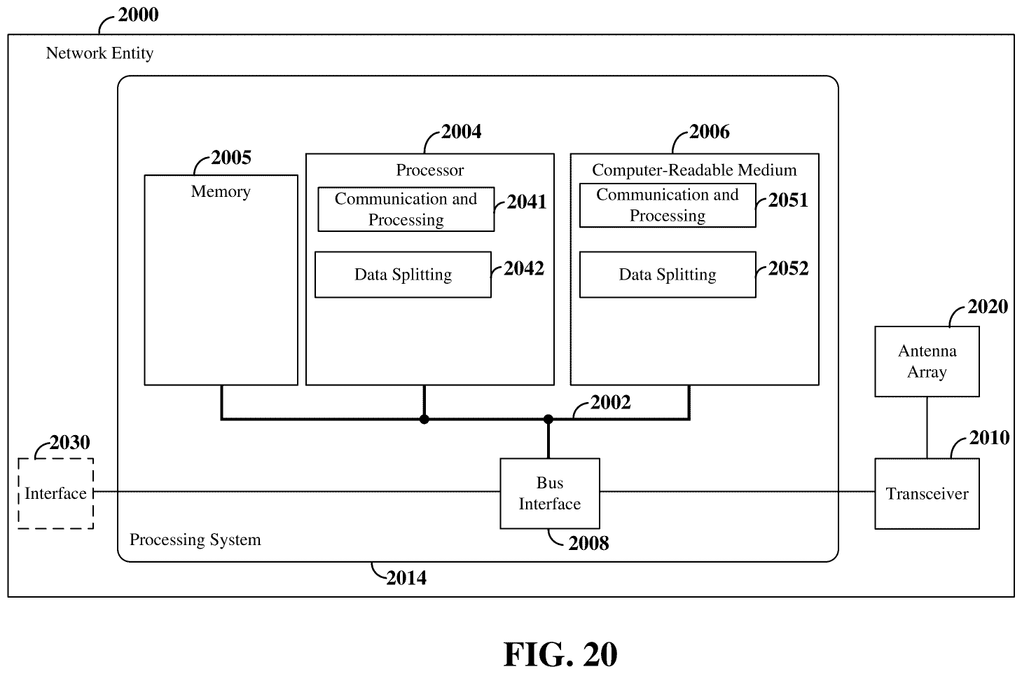

FIG. 20 is a block diagram illustrating an example of a hardware implementation for a network entity 2000 employing a processing system 2014 according to some aspects. In some implementations, the network entity 1800 may correspond to any of the UFP entities shown in any of FIGS. 4, 5, 6, 7, 8, 11, and 12.

In accordance with various aspects of the disclosure, an element, or any portion of an element, or any combination of elements may be implemented with the processing system 2014. The processing system may include one or more processors 2004. The processing system 2014 may be substantially the same as the processing system 1814 illustrated in FIG. 18, including a bus interface 2008, a bus 2002, memory 2005, a processor 2004, and a computer-readable medium 2006. Furthermore, the network entity 2000 may include an interface 2030 (e.g., a network interface) that provides a means for communicating with at least one other apparatus within a core network and with at least one radio access network.

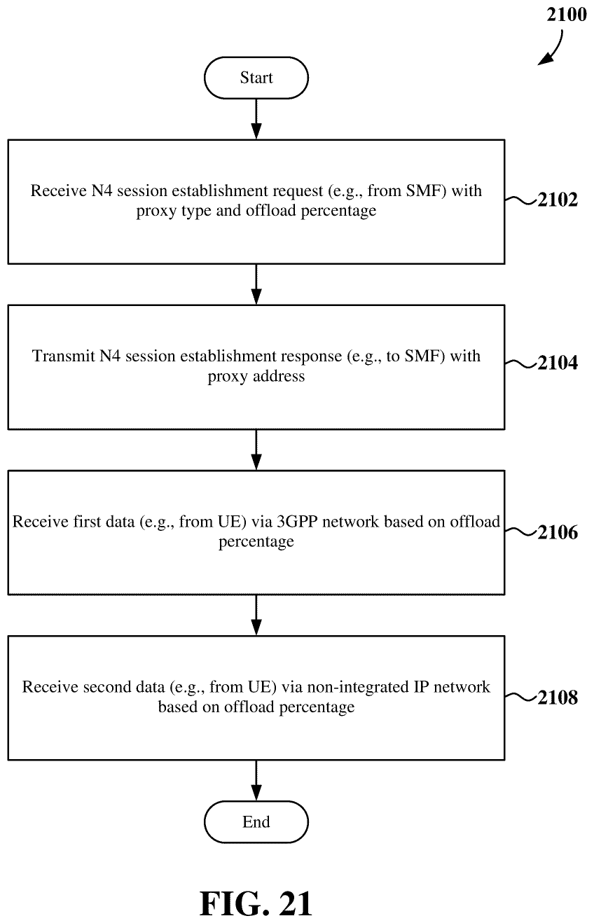

The network entity 2000 may be configured to perform any one or more of the operations described herein (e.g., as described above in conjunction with FIGS. 1-17 and as described below in conjunction with FIG. 21). In some aspects of the disclosure, the processor 2004, as utilized in the network entity 2000, may include circuitry configured for various functions.

The processor 2004 may be configured to generate, schedule, and modify a resource assignment or grant of time-frequency resources (e.g., a set of one or more resource elements). For example, the processor 2004 may schedule time-frequency resources within a plurality of time division duplex (TDD) and/or frequency division duplex (FDD) subframes, slots, and/or mini-slots to carry user data traffic and/or control information to and/or from multiple UEs.

The processor 2004 may further be configured to schedule resources for the transmission of an uplink signal. The processor 2004 may be configured to schedule uplink resources that may be utilized by the UE to transmit an uplink message (e.g., a PUCCH, a PUSCH, a PRACH occasion, or an RRC message). In some examples, the processor 2004 may be configured to schedule uplink resources in response to receiving a scheduling request from the UE.

In some aspects of the disclosure, the processor 2004 may include communication and processing circuitry 2041. The communication and processing circuitry 2004 may be configured to communicate with a UE. The communication and processing circuitry 2041 may include one or more hardware components that provide the physical structure that performs various processes related to communication (e.g., signal reception and/or signal transmission) as described herein. The communication and processing circuitry 2041 may further include one or more hardware components that provide the physical structure that performs various processes related to signal processing (e.g., processing a received signal and/or processing a signal for transmission) as described herein. The communication and processing circuitry 2041 may further be configured to execute communication and processing software 2051 included on the computer-readable medium 2006 to implement one or more functions described herein.

In some implementations wherein the communication involves receiving information, the communication and processing circuitry 2041 may obtain information from a component of the network entity 2000 (e.g., from the transceiver 2010 that receives the information via radio frequency signaling or some other type of signaling suitable for the applicable communication medium), process (e.g., decode) the information, and output the processed information. For example, the communication and processing circuitry 2041 may output the information to another component of the processor 2004, to the memory 2005, or to the bus interface 2008. In some examples, the communication and processing circuitry 2041 may receive one or more of signals, messages, other information, or any combination thereof. In some examples, the communication and processing circuitry 2041 may receive information via one or more channels. In some examples, the communication and processing circuitry 2041 may include functionality for a means for receiving. In some examples, the communication and processing circuitry 2041 may include functionality for a means for decoding.

In some implementations wherein the communication involves sending (e.g., transmitting) information, the communication and processing circuitry 2041 may obtain information (e.g., from another component of the processor 2004, the memory 2005, or the bus interface 2008), process (e.g., encode) the information, and output the processed information. For example, the communication and processing circuitry 2041 may output the information to the transceiver 2010 (e.g., that transmits the information via radio frequency signaling or some other type of signaling suitable for the applicable communication medium). In some examples, the communication and processing circuitry 2041 may send one or more of signals, messages, other information, or any combination thereof. In some examples, the communication and processing circuitry 2041 may send information via one or more channels. In some examples, the communication and processing circuitry 2041 may include functionality for a means for sending (e.g., a means for transmitting). In some examples, the communication and processing circuitry 2041 may include functionality for a means for encoding.

The processor 2004 may include communication and processing circuitry 2041 configured to perform N4 session establishment-related operations as discussed herein (e.g., one or more of the operations described in conjunction with FIGS. 11-12, and 21). The communication and processing circuitry 2041 may be configured to execute communication and processing software 2051 included on the computer-readable medium 2006 to implement one or more functions described herein.

The communication and processing circuitry 2041 may include functionality for a means for receiving an N4 session establishment request (e.g., from an SMF) with proxy type and offload percentage (e.g., as described in conjunction with #10a of FIG. 11 and/or block 2102 of FIG. 21).

The communication and processing circuitry 2041 may include functionality for a means for transmitting an N4 session establishment response (e.g., to an SMF) with proxy address information (e.g., as described in conjunction with #10b of FIG. 11 and/or block 2104 of FIG. 21).

The processor 2004 may include data splitting (and aggregation) circuitry 2042 configured to data splitting/aggregation-related operations as discussed herein (e.g., one or more of the operations described in conjunction with FIGS. 7-17). The data splitting circuitry 2042 may be configured to execute data splitting software 2052 included on the computer-readable medium 2006 to implement one or more functions described herein.

The data splitting circuitry 2042 may include functionality for a means for receiving first data (e.g., from UE) via a 3GPP network based on an offload percentage (e.g., as described in conjunction with block 2106 of FIG. 21).

The data splitting circuitry 2042 may include functionality for a means for receiving second data (e.g., from UE) via a non-integrated IP network based on an offload percentage (e.g., as described in conjunction with block 2108 of FIG. 21).

FIG. 21 is a flow chart illustrating an example method 2100 for communicating using non-integrated aggregation according to some aspects. As described herein, some or all illustrated features may be omitted in a particular implementation within the scope of the present disclosure, and some illustrated features may not be required for implementation of all examples. In some examples, the method 2100 may be carried out by the network entity 2000 illustrated in FIG. 20. In some examples, the method 2100 may be carried out by any suitable apparatus or means for carrying out the functions or algorithm described below.

At block 2102, a network entity (e.g., UPF) may receive an N4 session establishment request (e.g., from an SMF) with proxy type and offload percentage information. For example, the communication and processing circuitry 2041 together with the transceiver 2010, shown and described above in connection with FIG. 20, may provide a means to receive an N4 session establishment request (e.g., from an SMF) with proxy type and offload percentage information.

At block 2104, a network entity (e.g., UPF) may transmit an N4 session establishment response (e.g., to SMF) with a proxy address. For example, the communication and processing circuitry 2041 together with the transceiver 2010, shown and described above in connection with FIG. 20, may provide a means to transmit an N4 session establishment response (e.g., to SMF) with a proxy address.

At block 2106, a network entity (e.g., UPF) may receive first data (e.g., from a UE) via a 3GPP network based on an offload percentage. For example, the data splitting circuitry 2042 together with the transceiver 2010, shown and described above in connection with FIG. 20, may provide a means to receive first data (e.g., from a UE) via a 3GPP network based on an offload percentage.

At block 2108, a network entity (e.g., UPF) may receive second data (e.g., from a UE) via a non-integrated IP network based on an offload percentage. For example, the data splitting circuitry 2042 together with the transceiver 2010, shown and described above in connection with FIG. 20, may provide a means to receive second data (e.g., from a UE) via a non-integrated IP network based on an offload percentage.

In some examples, the UPF may also aggregate the first and second data for transmission to a data network (e.g., any of the data networks 716, 816, 1116).

In some examples, the UPF (or another core network entity) may also provide the UE with addresses for proxies at the UPF via either the 3GPP network or the non-integrated IP network.

Returning briefly to FIG. 7, one problem already addressed by the method of FIGS. 11-12 used on the multiple access network of FIG. 7, for example, is that the UPF, and consequently the proxy on it, is selected during the UPF selection process of the PDU session establishment, and hence the URSP rules may be unable to carry the final proxy information. Another way to address this problem is as follows. The proxy configuration may be done semi-statically. In some examples, a proxy table may be used to specify the proxy types and network addresses for each of the N3 and NX interfaces.

In some examples, the UPF/Proxy address mapping table can be either configured (semi) statically at the UE or provided via the URSP rules. In some examples, the proxy table may further include PLMN identifiers to enable static configuration for multiple PLMNs. As to information at the UE to specify the proxy type to use and the split percentage, the UE may use the URSP rules to get this information on a per application basis. In some examples, and as to the split percentage for uplink to UPF, this may not be needed as the UPF may decide this dynamically based on its load situation.

The methods shown in FIGS. 19 and 21 may include additional aspects, such as any single aspect or any combination of aspects described below and/or in connection with one or more other processes described elsewhere herein. The following provides an overview of several aspects of the present disclosure.

Aspect 1: A method for wireless communication at a user equipment (UE), the method comprising: communicating with a core network over a 3rd Generation Partnership Project (3GPP) network; transmitting a request to the core network for a protocol data unit (PDU) session comprising a request for data aggregation across the 3GPP network and a non-integrated internet protocol (IP) network; receiving a response from the core network granting the requested PDU session, the response comprising identification of a core network aggregation entity and an offload percentage; transmitting data to the core network aggregation entity via the non-integrated IP network based on the offload percentage; and transmitting data to the core network aggregation entity via the 3GPP network based on the offload percentage.

Aspect 2: The method of aspect 1, wherein the request to the core network for the PDU session further comprises at least one UE supported proxy type; wherein the response from the core network granting the requested PDU session comprises at least one supported proxy type for the core network aggregation entity, including the UE supported proxy type; and wherein the transmitting data to the core network aggregation entity via the non-integrated IP network based on the offload percentage comprises transmitting data, using a proxy type supported by both the UE and the core network aggregation entity, to the core network aggregation entity via the non-integrated IP network based on the offload percentage.

Aspect 3: the method of aspect 2, wherein the response from the core network granting the requested PDU session further comprises a network address for the core network aggregation entity for each of the 3GPP network and the non-integrated IP network; and wherein the transmitting data to the core network aggregation entity via the non-integrated IP network based on the offload percentage comprises transmitting data, using a proxy type supported by both the UE and the core network aggregation entity, to the core network aggregation entity using the network address of the non-integrated IP network in accordance with the offload percentage.

Aspect 4: the method of aspect 2, wherein the at least one UE supported proxy type comprises at least one of a multipath transmission control protocol (MPTCP) proxy type, a multiplexed application substrate over QUIC (MASQUE) proxy type using user datagram protocol (UDP), or a MASQUE proxy type using internet protocol (IP); and wherein the at least one supported proxy type for the core network aggregation entity comprises at least one of a MPTCP proxy type, a MASQUE proxy type using UDP, or a MASQUE proxy type using IP.

Aspect 5: the method of aspect 2, wherein the at least one supported proxy type comprises a multipath transmission control protocol (MPTCP) proxy type; and wherein the transmitting data to the core network aggregation entity via the non-integrated IP network based on the offload percentage comprises transmitting data, using the MPTCP proxy type and encryption provided by transport layer security (TLS), to the core network aggregation entity via the non-integrated IP network based on the offload percentage.

Aspect 6: the method of any of aspects 1-5, wherein the non-integrated IP network comprises a WiFi network; wherein the 3GPP network comprises a 5G network; and wherein the core network aggregation entity comprises a user plane function (UPF) device.

Aspect 7: the method of any of aspects 1-6, further comprising executing at least one application on the UE; wherein the transmitting the request to the core network for the PDU session comprising transmitting, from the at least one application, the request to the core network for the PDU session; and wherein the transmitting data to the core network aggregation entity via the non-integrated IP network based on the offload percentage comprises transmitting data, from the at least one application, to the core network aggregation entity via the non-integrated IP network based on the offload percentage.

Aspect 8: the method of any of aspects 1-7, wherein the request to the core network for the protocol data unit (PDU) session further comprises an indication of: a requested offload percentage; whether the UE supports a multipath transmission control protocol (MPTCP) proxy type; whether the UE supports a multiplexed application substrate over QUIC (MASQUE) proxy type using user datagram protocol (UDP); and whether the UE supports a MASQUE proxy type using internet protocol (IP).

Aspect 9: the method of any of aspects 1-8, wherein the response from the core network granting the requested PDU session further comprises an indication of: a granted offload percentage; whether the core network aggregation entity supports a multipath transmission control protocol (MPTCP) proxy type; whether the core network aggregation entity supports a multiplexed application substrate over QUIC (MASQUE) proxy type using user datagram protocol (UDP); and whether the core network aggregation entity supports a MASQUE proxy type using internet protocol (IP).

Aspect 10: the method of aspect 9, wherein the response from the core network granting the requested PDU session further comprises: a network address for the core network aggregation entity for each of the 3GPP network and the non-integrated IP network; and an indication of an IP address type of the network address for the core network aggregation entity for each of the 3GPP network and the non-integrated IP network.

Aspect 11: the method of any of aspects 1-10, wherein the transmitting the request to the core network for the PDU session comprises transmitting the request to the core network for the PDU session via the 3GPP network; and wherein the receiving the response from the core network granting the requested PDU session comprises receiving the response from the core network granting the requested PDU session via the 3GPP network.

Aspect 12: the method of any of aspects 1-10, wherein the non-integrated IP network is configured not to provide a non-3GPP interworking function (N3IWF).

Aspect 13: the method of any of aspects 1-12, wherein the offload percentage is indicative of a percentage of data traffic to be routed via the non-integrated IP network.

Aspect 14: the method of any of aspects 1-13, wherein the non-integrated IP network comprises a WiFi network; and wherein the 3GPP network comprises a 5G network.

Aspect 15: A user equipment comprising: a transceiver configured to communicate with a radio access network, a memory, and a processor coupled to the transceiver and the memory, wherein the processor is configured to perform any one of aspects 1 through 14.

Aspect 16: An apparatus configured for wireless communication (e.g., a UE) comprising at least one means for performing any one of aspects 1 through 14.

Aspect 17: A non-transitory computer-readable medium storing computer-executable code, comprising code for causing an apparatus to perform any one of aspects 1 through 14.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may encompass a wide variety of actions. For example, “determining” may include calculating, computing, processing, deriving, investigating, looking up (e.g., looking up in a table, a database or another data structure), ascertaining, resolving, selecting, choosing, establishing, receiving (e.g., receiving information), accessing (e.g., accessing data in a memory), and the like.

One or more of the components, steps, features and/or functions illustrated in FIGS. 1-21 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in any of FIGS. 1, 2, 4, 5, 6, 7, 8, 11, 12, 18, and 20 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE), comprising:
a transceiver; and
a processor coupled to the transceiver and configured to:
communicate with a core network over a 3rd Generation Partnership Project (3GPP) network;
transmit, via the transceiver, a request to the core network for a protocol data unit (PDU) session comprising a request for data aggregation across the 3GPP network and a non-integrated internet protocol (IP) network;
receive, via the transceiver, a response from the core network granting the requested PDU session, the response comprising identification of a core network aggregation entity and an offload percentage;
transmit data, via the transceiver, to the core network aggregation entity via the non-integrated IP network based on the offload percentage; and
transmit data, via the transceiver, to the core network aggregation entity via the 3GPP network based on the offload percentage.

2. The UE of claim 1:
wherein the request to the core network for the PDU session further comprises at least one UE supported proxy type;
wherein the response from the core network granting the requested PDU session comprises at least one supported proxy type for the core network aggregation entity, including the UE supported proxy type; and
wherein the processor is further configured to transmit data, using a proxy type supported by both the UE and the core network aggregation entity, to the core network aggregation entity via the non-integrated IP network based on the offload percentage.

3. The UE of claim 2,
wherein the response from the core network granting the requested PDU session further comprises a network address for the core network aggregation entity for each of the 3GPP network and the non-integrated IP network; and
wherein the processor is further configured to transmit data, using a proxy type supported by both the UE and the core network aggregation entity, to the core network aggregation entity using the network address of the non-integrated IP network in accordance with the offload percentage.

4. The UE of claim 2:
wherein the at least one UE supported proxy type comprises at least one of a multipath transmission control protocol (MPTCP) proxy type, a multiplexed application substrate over QUIC (MASQUE) proxy type using user datagram protocol (UDP), or a MASQUE proxy type using internet protocol (IP); and
wherein the at least one supported proxy type for the core network aggregation entity comprises at least one of a MPTCP proxy type, a MASQUE proxy type using UDP, or a MASQUE proxy type using IP.

5. The UE of claim 2:
wherein the at least one supported proxy type comprises a multipath transmission control protocol (MPTCP) proxy type; and
wherein the processor is further configured to transmit data, using the MPTCP proxy type and encryption provided by transport layer security (TLS), to the core network aggregation entity via the non-integrated IP network based on the offload percentage.

6. The UE of claim 1, wherein the offload percentage is indicative of a percentage of data traffic to be routed via the non-integrated IP network.

7. The UE of claim 1:
wherein the non-integrated IP network comprises a WiFi network; and
wherein the 3GPP network comprises a 5G network.

8. The UE of claim 1, wherein the core network aggregation entity comprises a user plane function (UPF) device.

9. The UE of claim 1:
wherein the UE comprises at least one application configured to execute on the UE;
wherein the processor configured to transmit the request to the core network for the PDU session is further configured to transmit, from the at least one application, the request to the core network for the PDU session; and
wherein the processor configured to transmit data to the core network aggregation entity via the non-integrated IP network based on the offload percentage is further configured to transmit data, from the at least one application, to the core network aggregation entity via the non-integrated IP network based on the offload percentage.

10. The UE of claim 1:
wherein the processor is further configured to receive a UE Route Selection Policy (URSP); and
wherein the processor configured to transmit the request to the core network for the PDU session is further configured to transmit the request to the core network for the PDU session based on the URSP.

11. The UE of claim 1, wherein the request to the core network for the protocol data unit (PDU) session further comprises an indication of:
a requested offload percentage;
whether the UE supports a multipath transmission control protocol (MPTCP) proxy type;
whether the UE supports a multiplexed application substrate over QUIC (MASQUE) proxy type using user datagram protocol (UDP); and
whether the UE supports a MASQUE proxy type using internet protocol (IP).

12. The UE of claim 1, wherein the response from the core network granting the requested PDU session further comprises an indication of:
a granted offload percentage;
whether the core network aggregation entity supports a multipath transmission control protocol (MPTCP) proxy type;
whether the core network aggregation entity supports a multiplexed application substrate over QUIC (MASQUE) proxy type using user datagram protocol (UDP); and
whether the core network aggregation entity supports a MASQUE proxy type using internet protocol (IP).

13. The UE of claim 12:
wherein the response from the core network granting the requested PDU session further comprises a network address for the core network aggregation entity for each of the 3GPP network and the non-integrated IP network; and
wherein the response from the core network granting the requested PDU session further comprises an indication of an IP address type of the network address for the core network aggregation entity for each of the 3GPP network and the non-integrated IP network.

14. The UE of claim 1:
wherein the processor is configured to transmit the request to the core network for the PDU session via the 3GPP network; and
wherein the processor is configured to receive the response from the core network granting the requested PDU session via the 3GPP network.

15. The UE of claim 1, wherein the non-integrated IP network is configured not to provide a non-3GPP interworking function (N3IWF).

16. A method for wireless communication at a user equipment (UE), the method comprising:
communicating with a core network over a 3rd Generation Partnership Project (3GPP) network;
transmitting a request to the core network for a protocol data unit (PDU) session comprising a request for data aggregation across the 3GPP network and a non-integrated internet protocol (IP) network;
receiving a response from the core network granting the requested PDU session, the response comprising identification of a core network aggregation entity and an offload percentage;
transmitting data to the core network aggregation entity via the non-integrated IP network based on the offload percentage; and
transmitting data to the core network aggregation entity via the 3GPP network based on the offload percentage.

17. The method of claim 16:
wherein the request to the core network for the PDU session further comprises at least one UE supported proxy type;
wherein the response from the core network granting the requested PDU session comprises at least one supported proxy type for the core network aggregation entity, including the UE supported proxy type; and
wherein the transmitting data to the core network aggregation entity via the non-integrated IP network based on the offload percentage comprises transmitting data, using a proxy type supported by both the UE and the core network aggregation entity, to the core network aggregation entity via the non-integrated IP network based on the offload percentage.

18. The method of claim 17,
wherein the response from the core network granting the requested PDU session further comprises a network address for the core network aggregation entity for each of the 3GPP network and the non-integrated IP network; and
wherein the transmitting data to the core network aggregation entity via the non-integrated IP network based on the offload percentage comprises transmitting data, using a proxy type supported by both the UE and the core network aggregation entity, to the core network aggregation entity using the network address of the non-integrated IP network in accordance with the offload percentage.

19. The method of claim 17:
wherein the at least one UE supported proxy type comprises at least one of a multipath transmission control protocol (MPTCP) proxy type, a multiplexed application substrate over QUIC (MASQUE) proxy type using user datagram protocol (UDP), or a MASQUE proxy type using internet protocol (IP); and
wherein the at least one supported proxy type for the core network aggregation entity comprises at least one of a MPTCP proxy type, a MASQUE proxy type using UDP, or a MASQUE proxy type using IP.

20. The method of claim 17:
wherein the at least one supported proxy type comprises a multipath transmission control protocol (MPTCP) proxy type; and
wherein the transmitting data to the core network aggregation entity via the non-integrated IP network based on the offload percentage comprises transmitting data, using the MPTCP proxy type and encryption provided by transport layer security (TLS), to the core network aggregation entity via the non-integrated IP network based on the offload percentage.

21. The method of claim 16:
wherein the non-integrated IP network comprises a WiFi network;
wherein the 3GPP network comprises a 5G network; and
wherein the core network aggregation entity comprises a user plane function (UPF) device.

22. The method of claim 16, further comprising:
executing at least one application on the UE;
wherein the transmitting the request to the core network for the PDU session comprising transmitting, from the at least one application, the request to the core network for the PDU session; and
wherein the transmitting data to the core network aggregation entity via the non-integrated IP network based on the offload percentage comprises transmitting data, from the at least one application, to the core network aggregation entity via the non-integrated IP network based on the offload percentage.

23. The method of claim 16:
receiving a UE Route Selection Policy (URSP); and
wherein the transmitting the request to the core network for the PDU session comprises transmitting the request to the core network for the PDU session based on the URSP.

24. The method of claim 16, wherein the request to the core network for the protocol data unit (PDU) session further comprises an indication of:
a requested offload percentage;
whether the UE supports a multipath transmission control protocol (MPTCP) proxy type;
whether the UE supports a multiplexed application substrate over QUIC (MASQUE) proxy type using user datagram protocol (UDP); and
whether the UE supports a MASQUE proxy type using internet protocol (IP).

25. The method of claim 16, wherein the response from the core network granting the requested PDU session further comprises an indication of:
a granted offload percentage;
whether the core network aggregation entity supports a multipath transmission control protocol (MPTCP) proxy type;
whether the core network aggregation entity supports a multiplexed application substrate over QUIC (MASQUE) proxy type using user datagram protocol (UDP); and
whether the core network aggregation entity supports a MASQUE proxy type using internet protocol (IP).

26. The method of claim 25:
wherein the response from the core network granting the requested PDU session further comprises:
a network address for the core network aggregation entity for each of the 3GPP network and the non-integrated IP network; and
an indication of an IP address type of the network address for the core network aggregation entity for each of the 3GPP network and the non-integrated IP network.

27. The method of claim 16:
wherein the transmitting the request to the core network for the PDU session comprises transmitting the request to the core network for the PDU session via the 3GPP network; and
wherein the receiving the response from the core network granting the requested PDU session comprises receiving the response from the core network granting the requested PDU session via the 3GPP network.

28. The method of claim 16, wherein the non-integrated IP network is configured not to provide a non-3GPP interworking function (N3IWF).

29. A user equipment (UE), comprising:
means for communicating with a core network over a 3rd Generation Partnership Project (3GPP) network;
means for transmitting a request to the core network for a protocol data unit (PDU) session comprising a request for data aggregation across the 3GPP network and a non-integrated internet protocol (IP) network;
means for receiving a response from the core network granting the requested PDU session, the response comprising identification of a core network aggregation entity and an offload percentage;
means for transmitting data to the core network aggregation entity via the non-integrated IP network based on the offload percentage; and
means for transmitting data to the core network aggregation entity via the 3GPP network based on the offload percentage.

30. (canceled)
